(19) United States
(12) Patent Application Publication
(10) Pub. No.: US 2012/0095876 A1
(43) Pub. Date: Apr. 19, 2012

(54) ADVANCE ORDER PROCESSING APPARATUS, PROGRAM OF ADVANCE ORDER PROCESSING APPARATUS, AND ADVANCE ORDER PROCESSING SYSTEM

(76) Inventor: Kazuo Miyashita, Tsukuba (JP)

(21) Appl. No.: 13/376,525

(22) PCT Filed: Feb. 24, 2010
(86) PCT No.: PCT/JP10/01228

§ 371 Date: Dec. 6, 2011

(30) Foreign Application Priority Data
Jun. 25, 2009 (JP) 2009-151513

(51) Int. Cl. G06Q 30/00

(52) U.S. Cl. 705/26.81

(57) ABSTRACT

There is provided an advance order processing apparatus 10 which executes, for an object whose estimated value and result value may be different, processing of receiving an advance order on the basis of an estimated value and confirming the advance order on the basis of a result value. This includes: an advance order information storage means for storing information regarding provisional advance orders and information regarding alternative advance orders so as to match each other; a change mode information storage means for storing information which specifies a mode of changing an alternative advance order to a provisional advance order according to an approval situation of a provisional advance order for the information regarding the corresponding provisional advance order and the information regarding the corresponding alternative advance order stored; a result value information acquisition means for acquiring the result value information; an advance order confirming means for confirming the approval situation of a provisional advance order on the basis of the result value information; and an advance order update means for changing a corresponding alternative advance order to a provisional advance order according to an approval situation of a provisional advance order depending on the storage content of the change mode information storage means and reflecting the result on the storage content of the advance order information storage means.

### TECHNICAL FIELD

The present invention relates to an advance order direct trading method and an advance order direct trading system capable of realizing a trade which meets the needs of the advance order trade participants on both the sales and purchase sides while avoiding the risks involved in a contract in an advance order direct trade for perishable products, such as seafood or vegetables and fruit, the shipment of which is not decided at the time of an advance order, for example.

### BACKGROUND ART

In recent years, concerning trading methods for perishable products, such as vegetables and fruit or seafood, not only conventional auctions where the local producers and the buyers do not make contracts in advance but also direct trades in which contracts between the local producers and the buyers are made in advance tend to increase according to changes in the external environment surrounding the wholesale market, such as an increase in the size of the production center, an increase in the number of mass retail stores including supermarkets, an increase in imported food, development of the food service industry, and the development of cold chains.

Cases of direct trade include a case where the price is decided through talks while seeing actual products arrived in a market every day and a case where a buyer gives an advance order to a local producer before shipment by the local producer so that the products are reliably shipped for sale. The latter case is called an “advance order direct trade”, and is a trade form in which deadlines, product kinds, and quantities traded are decided in advance. In restaurants and ready-made meal companies and supermarkets, there are demands for ensuring a stable supply of the required products while avoiding the risks caused by price volatility or supply instability. Accordingly, the volume of this “advance order direct trade” has been increasing in recent years.

Some systems for supporting the execution of such an advance order direct trade by an information processing system have already been implemented in the trade of vegetables and fruit and the like. These systems have a function capable of checking and saving the content (for example, quantity, price, schedule, and the like) of a trade terminal connected to the Internet, which is input from both sides of a sales side such as a local producer and a purchase side such as a wholesaler (wholesale company), when necessary so that an advance order direct trade can be smoothly processed.

### RELATED ART DOCUMENT

### Citation List

[PTL 1] JP-A-2005-332230
[NPL 1] Matsuda Tomoyoshi, “New trade in the agricultural market: information market in Japan”, academic report of the horticultural department in Chiba University, Vol. 48 (1994. 03. 25), pp. 163-173

### SUMMARY OF INVENTION

### Technical Problem

In the conventional advance order direct trade described above, however, deciding the details of a trade is left completely to persons in charge on the sales and purchase sides. In particular, in the case of fishery products such as seafood the shipments of which greatly vary according to circumstances, such as the weather, the purchasing manager of a supermarket or the like who needs to secure a lot of products needs to decide with whom to trade and how much to trade based on past results data or his or her experience in order to secure the required products in the required amount.

Therefore, except for some products which are not easily influenced by the weather or the like, there has been a possibility that even in an advance order direct trade, the required amount will not be secured or on the other hand, more products will be purchased than needed because too many products were ordered in advance to make a reliable purchase. The producer also has to pay the buyer charges for breach of contract if the products and the quantity set in the advance order trade cannot be shipped to the buyer by the due date. For this reason, it was very difficult in practice to participate in an advance order direct trade except for large-scale producers with sufficient production capacity.

The present invention has been made in view of such a situation in the related art, and it is a main object of the present invention to provide an advance order processing apparatus, an advance order processing system, and the like capable of realizing an advance order direct trade support method or an advance order direct trade support system capable of realizing the required appropriate product trade without taking risks, such as breach of contract or purchase failure, on the sales side or the purchase side in an advance order direct trade in fresh products and the like the shipments of which change depending on the weather or the like.

### Solution to Problem

In order to achieve the above-described object, in the present invention, the following advance order processing apparatuses (1) to (12) are provided.

(1) An advance order processing apparatus which executes, for one or more objects (for example, various kinds of products) whose estimated value which is an estimated amount (amount, such as a number) of the acquisition and a result value which is an (actual) amount (amount, such as a number) of acquisition of results decided thereafter may be different, the processing of receiving an advance order including at least a desired amount (amount, such as a desired number) of the object on the basis of the estimated value before the result value comes out and confirming an advance order on the basis of the result value after the result value comes out is characterized in that it includes: an estimated value storage means (for example, a database or various kinds of memories) for storing estimated value information regarding the object; a result value storage means (for example, a database or various kinds of memories) for storing result value information regarding the object; an advance order information receiving means for receiving information regarding a corresponding provisional advance order and information regarding a corresponding alternative advance order for a provisional advance order, which is made (for example, by the purchase side) on the basis of the estimated value information regarding the object stored in the estimated value storage means and which includes at least a desired amount of the object, and an alternative advance order, which is alternatively changed to a provisional advance order if the situation is not an approval situation (for example, in the case of an approval situation called “partially approved” or “not approved”) where all of the corresponding provisional advance orders are approved and which includes at least a desired amount of the object; an advance order information storage means (for example, a database or various kinds of memories) for storing information regarding provisional advance orders and information regarding alternative advance orders received by the advance order information receiving means so that the information regarding a corresponding provisional advance order and the information regarding a corresponding alternative advance order match each other; a change mode information storage means (for example, a database or various kinds of memories) for storing information which specifies a mode of changing an alternative advance order to a provisional advance order according to an approval situation (for example, an approval situation called “partially approved” or “not approved”) of a provisional advance order for the information regarding the corresponding provisional advance order and the information regarding the corresponding alternative advance order stored in the advance order information storage means; a result value information acquisition means for executing the processing of acquiring result value information regarding the object (for example, from the sales side) and storing the acquired result value information in the result value storage means; an advance order confirming means for executing processing of reading the information regarding a provisional advance order stored in the advance order information storage means and determining an approval situation of a provisional advance order on the basis of the result value information acquired by the result value information acquisition means and confirming the approval situation of a provisional advance order for the read information regarding the provisional advance order and executing processing of changing the storage content of the advance order information storage means so that the information regarding an advance order whose approval situation has been confirmed is deleted from objects whose approval situations are to be checked; and an advance order update means for executing processing of reading the storage content of the change mode information storage means, changing a corresponding alternative advance order to a provisional advance order according to an approval situation (for example, in an approval situation called “partially approved” or “not approved”) of a provisional advance order confirmed by the advance order confirming means depending on the read content, and changing the corresponding storage content such that the result is reflected on the storage content of the advance order information storage means.

Accordingly, it is possible to effectively realize processing regarding an advance order of an object whose estimated value, which is an estimated amount of acquisition, and a result value, which is an amount of acquisition of results decided thereafter may be different.

(2) The advance order processing apparatus described in (1) described above is characterized in that it further includes an information display means for advance order reception for executing processing of displaying (for example, on a screen) information for receiving an advance order from a purchase side user in the apparatus (corresponding advance order processing apparatus) or an external terminal device and that the advance order information receiving means executes processing of receiving a provisional advance order and an alternative advance order, which corresponds to the provisional advance order, according to an operation (for example, of a keyboard or a mouse) of the purchase side user, which is performed on the basis of the display content of the information display means for advance order reception, and storing the received information regarding the provisional advance order and the information regarding the alternative advance order in the advance order information storage means.

Accordingly, it is possible to effectively realize processing for receiving a provisional advance order or an alternative advance order.

(3) The advance order processing apparatus described in (2) above is characterized in that it further includes a change mode information receiving means for executing, for the provisional advance order and the alternative advance order corresponding to the provisional advance order which are received by the advance order information receiving means, receiving information, which specifies a mode of changing an alternative advance order to a provisional advance order according to an approval situation (for example, an approval situation called “partially approved” or “not approved”) of a provisional advance order, according to an operation (for example, of a keyboard or a mouse) of the purchase side user and storing the received information in the change mode information storage means.

Accordingly, it is possible to effectively realize processing for receiving the information which specifies a mode of changing an alternative advance order to a provisional advance order according to an approval situation of a provisional advance order.

(4) The advance order processing apparatus described in anyone of (1) to (3) described above is characterized in that it further includes: an alternative advance order candidate information decision means for executing processing of deciding, for the object, information regarding a provisional advance order and a candidate (for example, one or more candidates) of a corresponding alternative advance order or information regarding a candidate (for example, one or more candidates) of an alternative advance order corresponding to a provisional advance order designated by the purchase side user, on the basis of the information regarding the estimated value of the object and the information regarding advance orders stored in the advance order information storage means (for example, on the basis of a residual quantity of objects which can be reserved at this point in time); a candidate information display means for executing processing of displaying (for example, on a screen) information regarding candidates decided by the alternative advance order candidate information decision means in the apparatus (corresponding advance order processing apparatus) or an external terminal device; and a candidate approval instruction receiving means for executing processing of receiving a candidate approval instruction according to an operation (for example, of a keyboard or a mouse) of the purchase side user, which is performed on the basis of the display content of the candidate information display means and storing advance order (for example, a set of alternative advance orders corresponding to a provisional advance order or an alternative advance order of a provisional advance order designated by a purchase side user) information regarding the instructed candidate in the advance order information storage means.

Accordingly, the advance order procedure of a user can be simplified by supporting it by presenting candidates of a provisional advance order and an alternative advance order or candidates of an alternative advance order of a certain provisional advance order and receiving a candidate approved by the user as an advance order formally.

(5) The advance order processing apparatus described in anyone of (1) to (4) described above is characterized in that an advance order mode called a normal advance order, which has priority over a provisional advance order and an alternative advance order and which includes at least a desired amount of the object, is set for the object, also for a normal advance order made (for example, by the purchase side) for the object on the basis of the estimated value information stored in the estimated value storage means, the advance order information receiving means receives information regarding the normal advance, order and stores the received information regarding the normal advance order in the advance order information storage means, and the advance order confirming means executes processing of reading the information regarding a normal advance order and the information regarding a provisional advance order stored in the advance order information storage means and determining an approval situation of a normal advance order and an approval situation of a provisional advance order on the basis of the result value information acquired by the result value information acquisition means and confirming the approval situation of a normal advance order and the approval situation of a provisional advance order for the read information regarding the normal advance order and information regarding the provisional advance order, and executes processing of changing the storage content of the advance order information storage means so that the information regarding an advance order whose approval situation has been confirmed is deleted from objects whose approval situations are to be checked.

Accordingly, it is possible to effectively realize processing regarding a normal advance order.

(6) The advance order processing apparatus described in (5) described above is characterized in that it further includes an advance order replacing means for executing processing, when there is a designation of a normal advance order overlapping a provisional advance order already present, receiving the designation of the normal advance order and also deleting information regarding the provisional advance order already present and changing information regarding an alternative advance order, which can be alternatively changed to a provisional advance order, to information regarding a provisional advance order only when there is an alternative advance order corresponding to the provisional advance order already present which can be alternatively changed to a provisional advance order and that the advance order information receiving means executes processing of receiving information regarding a normal advance order according to an operation (for example, of a keyboard or a mouse) of the purchase side user, which is performed on the basis of the display content of the information display means for advance order reception, and storing the received information regarding the normal advance order in the advance order information storage means, and in this case, the advance order replacing means executes processing of reading the storage content of the advance order information storage means, determining whether or not there is an alternative advance order corresponding to the provisional advance order already present which can be alternatively changed to a provisional advance order on the basis of the read content when there is a designation of a normal advance order overlapping a provisional advance order already present, and receiving the designation of the normal advance order and also deleting information regarding the provisional advance order already present from the storage content of the advance order information storage means and changing the storage content so that the information regarding the alternative advance order which can be alternatively changed to the provisional advance order is changed to the information regarding a provisional advance order only when there is an alternative advance order corresponding to the provisional advance order already present which can be alternatively changed to a provisional advance order.

Accordingly, it is possible to effectively realize processing regarding a normal advance order when there is a designation of a normal advance order overlapping a provisional advance order already present.

(7) The advance order processing apparatus described in (5) or (6) described above is characterized in that “all approved” or “not approved” is used as an approval situation of a normal advance order.

Therefore, as an example, an approval situation, such as “all approved” or “not approved”, for a normal advance order is confirmed on the basis of the residual quantity (actual residual quantity of objects at this point in time) obtained by subtracting objects already assigned to other advance orders from the result value.

(8) The advance order processing apparatus described in (5) or (6) described above is characterized in that “all approved”, “partially approved”, or “not approved” is used as an approval situation of a normal advance order.

Therefore, as an example, an approval situation, such as “all approved”, “partially approved”, or “not approved”, for a normal advance order is confirmed on the basis of the residual quantity (actual residual quantity of objects at this point in time) obtained by subtracting objects already assigned to other advance orders from the result value.

(9) The advance order processing apparatus described in any one of (1) to (8) described above is characterized in that “all approved” or “not approved” is used as an approval situation of a provisional advance order.

Therefore, as an example, an approval situation, such as “all approved” or “not approved”, for a provisional advance order is confirmed on the basis of the residual quantity (actual residual quantity of objects at this point in time) obtained by subtracting obj ects already assigned to other advance orders from the result value.

(10) The advance order processing apparatus described in any one of (1) to (8) described above is characterized in that “all approved”, “partially approved”, or “not approved” is used as an approval situation of a provisional advance order.

Therefore, as an example, an approval situation, such as “all approved”, “partially approved”, or “not approved”, for a provisional advance order is confirmed on the basis of the residual quantity (actual residual quantity of objects at this point in time) obtained by subtracting objects already assigned to other advance orders from the result value.

(11) The advance order processing apparatus described in any one of (1) to (10) described above is characterized in that when there is a plurality of alternative advance orders corresponding to the same provisional advance order, priorities for change to a provisional advance order are set, and an alternative advance order priority storage means (for example, a database or various kinds of memories) for storing information regarding priorities for change of a plurality of alternative advance orders, which corresponds to the same provisional advance order, to provisional advance orders is provided.

Accordingly, for example, since the priorities of a plurality of alternative advance orders corresponding to the same provisional advance order are automatically set by a user or an apparatus, change from an alternative advance order to a provisional advance order can be performed according to the order (priority) of the change when there is a need for a change from an alternative advance order to a provisional advance order.

In addition, it is also possible to provide a program for realizing the advance order processing apparatus described above. The following is an example.

(12) A program causes a computer that forms an advance order processing apparatus which executes, for one or more objects whose estimated value that is an estimated amount of acquisition and a result value that is an amount of acquisition of results decided thereafter may be different, processing of receiving an advance order including at least a desired amount of the object on the basis of the estimated value before the result value comes out and confirming an advance order on the basis of the result value after the result value comes out to realize: a function of storing estimated value information regarding the object in an estimated value storage means; an advance order information receiving function of receiving information regarding a corresponding provisional advance order and information regarding a corresponding alternative advance order for a provisional advance order, which is made on the basis of the estimated value information regarding the object stored in the estimated value storage means and which includes at least a desired amount of the object, and an alternative advance order, which is alternatively changed to a provisional advance order if the situation is not an approval situation where all of the corresponding provisional advance orders are approved and which includes at least a desired amount of the object; a function of storing, in an advance order information storage means, information regarding provisional advance orders and information regarding alternative advance orders received by the advance order information receiving function so that the information regarding a corresponding provisional advance order and the information regarding a corresponding alternative advance order match each other; a function of storing, in a change mode information storage means, information which specifies a mode of changing an alternative advance order to a provisional advance order according to an approval situation of a provisional advance order for the information regarding the corresponding provisional advance order and the information regarding the corresponding alternative advance order stored in the advance order information storage means; a result value information acquisition function of executing processing of acquiring result value information regarding the object and storing the acquired result value information in the result value storage means; an advance order confirming function of executing processing of reading the information regarding a provisional advance order stored in the advance order information storage means and determining an approval situation of a provisional advance order on the basis of the result value information acquired by the result value information acquisition function and confirming the approval situation of a provisional advance order for the read information regarding the provisional advance order and executing processing of changing the storage content of the advance order information storage means so that the information regarding an advance order whose approval situation has been confirmed is deleted from objects whose approval situations are to be checked; and an advance order update function of executing processing of reading the storage content of the change mode information storage means, changing a corresponding alternative advance order to a provisional advance order according to an approval situation of a provisional advance order confirmed by the advance order confirming function depending on the read content, and changing the corresponding storage content such that the result is reflected on the storage content of the advance order information storage means.

In addition, it is also possible to provide an advance order processing system including the advance order processing apparatus described above. The following is an example.

(13) An advance order processing system is characterized in that it includes: an advance order processing apparatus which executes, for one or more objects whose estimated value that is an estimated amount of acquisition and a result value that is an amount of acquisition of results decided thereafter may be different, processing of receiving an advance order including at least a desired amount of the object on the basis of the estimated value before the result value comes out and confirming an advance order on the basis of the result value after the result value comes out; a sales side terminal device which executes processing of communicating information regarding advance order processing (for example, information regarding an estimated value or a result value) through a network with the advance order processing apparatus operated by a sales side user of a product as the object; and a purchase side terminal device which executes processing of communicating information regarding advance order processing (for example, information necessary for making an advance order) through a network with the advance order processing apparatus operated by a purchase side user of a product as the object. The advance order processing apparatus includes: an estimated value storage means for storing estimated value information regarding the object; a result value storage means for storing result value information regarding the object; an advance order information receiving means for receiving information regarding a corresponding provisional advance order and information regarding a corresponding alternative advance order for a provisional advance order, which is made on the basis of the estimated value information regarding the object stored in the estimated value storage means and which includes at least a desired amount of the object, and an alternative advance order, which is alternatively changed to a provisional advance order if the situation is not an approval situation where all of the corresponding provisional advance orders are approved and which includes at least a desired amount of the object; an advance order information storage means for storing information regarding provisional advance orders and information regarding alternative advance orders received by the advance order information receiving means so that the information regarding a corresponding provisional advance order and the information regarding a corresponding alternative advance order match each other; a change mode information storage means for storing information which specifies a mode of changing an alternative advance order to a provisional advance order according to an approval situation of a provisional advance order for the information regarding the corresponding provisional advance order and the information regarding the corresponding alternative advance order stored in the advance order information storage means; a result value information acquisition means for executing processing of acquiring result value information regarding the object and storing the acquired result value information in the result value storage means; an advance order confirming means for executing processing of reading the information regarding a provisional advance order stored in the advance order information storage means and determining an approval situation of a provisional advance order on the basis of the result value information acquired by the result value information acquisition means and confirming the approval situation of a provisional advance order for the read information regarding the provisional advance order and executing processing of changing the storage content of the advance order information storage means so that the information regarding an advance order whose approval situation has been confirmed is deleted from objects whose approval situations are to be checked; and an advance order update means for executing processing of reading the storage content of the change mode information storage means, changing a corresponding alternative advance order to a provisional advance order according to an approval situation of a provisional advance order confirmed by the advance order confirming means depending on the read content, and changing the corresponding storage content such that the result is reflected on the storage content of the advance order information storage means.

### Advantageous Effects of Invention

As described above, according to the present invention, in an advance order direct trade of fresh products and the like shipments of which change depending on the weather or the like, for example, it is possible to realize a required appropriate product trade without taking risks, such as breach of contract or purchase failure, on the sales side or the purchase side.

As a specific example, for a small fishery cooperative or the like, there is an advantage in that “it is not possible to meet a large order independently, but it is possible to meet a large order if some fishery cooperatives cooperate”, an advantage in that “it is possible to make a reasonable production plan from the amount ordered in advance”, and as a result, an advantage in that “a market expands due to being in charge of one section of a large order”. In addition, for a large quantity buyer, there is an advantage in that the demands for “a required amount can be reliably secured without being committed to one place of production” are met, an advantage in that “products can be supplied at a stable price because they can be ordered in advance from a variety of places of production”, and as a result, an advantage in that “the number of large quantity suppliers increases and the stability in large quantity purchasing increases accordingly”.

### BRIEF DESCRIPTION OF DRAWINGS

FIG. 1 is a view showing an example of a connection state of an advance order direct trade support system to which the present invention is applied.

FIG. 2 is a view showing an example of the main hardware configuration of a sales side terminal and a purchase side terminal.

FIG. 3 is a view showing an example of the main hardware configuration of an advance order direct trade server.

FIG. 4 is a view showing an example of the main configuration in an external storage device of the advance order direct trade server.

FIG. 5 is a view showing an example of the main configuration of a seller DB in the present embodiment.

FIG. 6 is a view showing an example of the main configuration of a product DB in the present embodiment.

FIG. 7 is a view showing an example of the main configuration of a buyer DB in the present embodiment.

FIG. 8 is a view showing an example of the main configuration of an inventory DB in the present embodiment.

FIG. 9 is a view showing an example of the main configuration of an order DB in the present embodiment.

FIG. 10 is a view showing an example of an inventory management flow chart in the present embodiment.

FIG. 11 is a view showing an example of an order management flow chart in the present embodiment.

FIG. 12 is a view showing an example of an alternative order registration flow chart in the order management in the present embodiment.

FIG. 13 is a view showing an example of a normal order registration flow chart in the order management in the present embodiment.

FIG. 14 is a view showing an example of an order assignment flow chart in the present embodiment.

FIG. 15 is a view showing an example of a fishing port area selection screen of a purchase side terminal in the present implementation example.

FIG. 16 is a view showing an example of a fish species selection screen of a purchase side terminal in the present implementation example.

FIG. 17 is a view showing an example of an order input screen of a purchase side terminal in the present implementation example.

FIG. 18 is a view showing an example of a fishery cooperative order screen of a purchase side terminal in the present implementation example.

FIG. 19 is a view showing an example of an advance order confirmation screen of a purchase side terminal in the present implementation example.

FIG. 20 is a view showing an example of a fish species selection screen of a sales side terminal in the present implementation example.

FIG. 21 is a view showing an example of a landing information input screen of a sales side terminal in the present implementation example.

FIG. 22 is a view showing an example of an advance order assignment confirmation screen of a sales side terminal in the present implementation example.

### DESCRIPTION OF EMBODIMENTS

### Outline of the Present Embodiment

In the present embodiment, in order to solve the above-described problem, an advance order direct trade support method and an advance order direct trade support system are provided.

The advance order direct trade support system related to the present embodiment is an advance order direct trade support system in the trading of agricultural and fishery products or the like in which a plurality of sales side terminals, which are operated by sellers involved in production or shipment of agricultural and fishery products, and a plurality of purchase side terminals, which are operated by buyers involved in purchasing or ordering agricultural and fishery products from the sellers, are connected to a communication network which is connectable to an advance order direct trade server that adjusts the execution of an advance order direct trade according to the production circumstances of the agricultural and fishery products and the order therefor.

The greatest feature of the present embodiment is that the advance order direct trade server has an order management program and an advance order assignment program. The order management program has an advance order replacing means for distinguishing a normal order, which designates specific products, from an alternative order for products in a range satisfying the conditions and accepting the normal order for the specific products by replacement of an inventory secured for alternative orders when an inventory for meeting normal orders for the specific products is not sufficient. The advance order assignment program has an advance order update means for reducing the failure of assignment to an alternative order by repeatedly creating an order for products in a range satisfying the conditions while changing an object to be ordered in advance, the quantity, and the like until the quantity ordered is fulfilled for an alternative order.

### Explanations of the Present Embodiment

Hereinafter, one form of executing the present invention will be described with reference to the drawings.

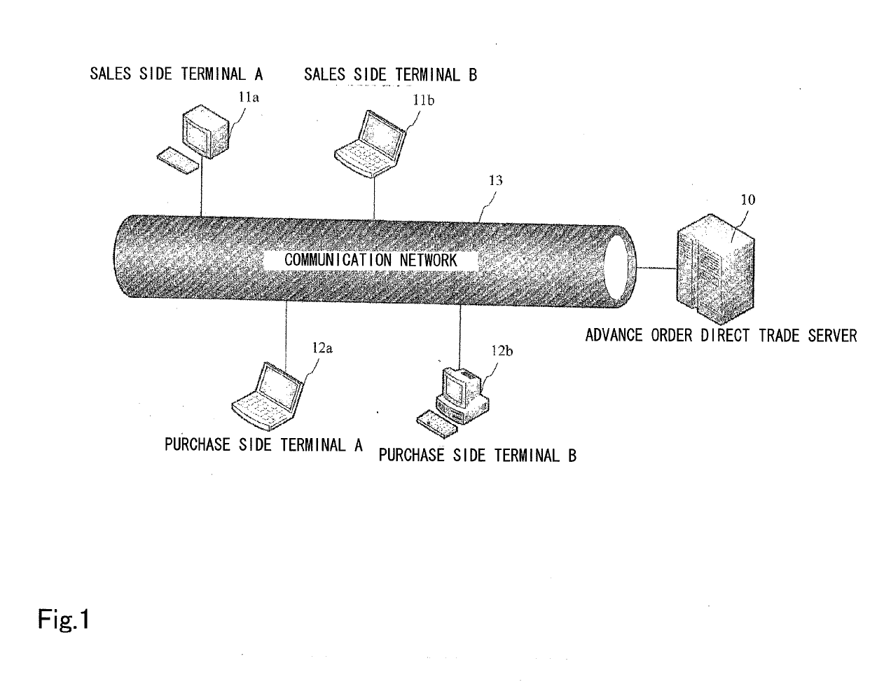

FIG. 1 is a view showing the configuration of main parts of an online advance order direct trade support system related to one embodiment of the present invention.

In the advance order direct trade support system of this example, apparatuses called an advance order direct trade server 10 formed by a computer, for example, a plurality of sales side terminals 11a and 11b formed by a computer, a personal digital assistant, and the like, for example, and a plurality of purchase side terminals 12a and 12b formed by a computer, a personal digital assistant, and the like, for example, are connected to each other through a communication network 13.

In FIG. 1, the advance order direct trade server 10 is managed by a broker, such as a wholesaler or a market, in order to sell products for which neither a tradable amount nor a fair price can be decided unless it is a trade date (for example, perishable products such as agricultural products or fishery products) by advance order before the trade date, and is an arithmetic unit that performs processing, such as inventory management or order management for an advance order direct trade, advance order assignment, and the like, among trades of agricultural products performed through the communication network 13, such as a telephone line or the Internet, by the sales side terminal 11 (11a, 11b), which is used by a plurality of sellers who wants to sell products by advance order, and the purchase side terminal 12 (12a, 12b), which is used by a plurality of buyers who wants to purchase products by advance order.

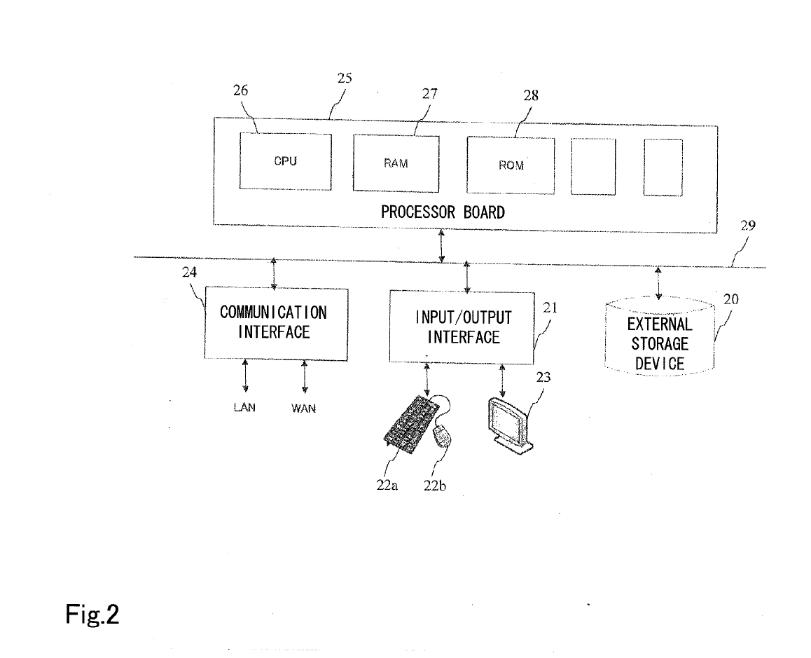

FIG. 2 is a view showing the main hardware configuration of the sales side terminal 11 or the purchase side terminal 12.

In the sales side terminal 11 or the purchase side terminal 12 of this example, an external storage device 20, an input/output interface 21 connected to a keyboard 22a, a mouse 22b, a display (screen) 23, or the like, a communication interface 24 connected to a LAN (Local Area Network), a WAN (Wide Area Network), or the like, and a processor board 25 having a CPU (Central Processing Unit) 26, a RAM (Random Access Memory) 27, a ROM (Read Only Memory) 28, and the like are connected to each other through a system bus 29.

In FIG. 2, a program for realizing user interface necessary for a seller or a buyer to perform advance order direct trading is stored in the external storage device 20 which is formed by a hard disk, a magneto-optical disk, a semiconductor memory, or the like. In the case of an advance order direct trading system using the Internet, a general-purpose program called a browser for viewing WEB pages is used as this program. The input/output interface 21 is a device for making it possible to use devices which perform inputting and outputting, such as the mouse 22b or the keyboard 22a which is an example of an input device and the display 23 which is an example of an output device. The communication interface 24 is a device for connecting the sales side terminal 11 or the purchase side terminal 12 to the communication network. The processor board 25 is a device for performing information processing in the sales side terminal 11 or the purchase side terminal 12 and includes components, such as the CPU 26 for performing computation, the RAM 27 for temporary storage, and the ROM 28 for storing a program and the like.

The external storage device 20, the input/output interface 21, the communication interface 24, and the processor board 25 are connected to each other by the system bus 29 to operate. Since the sales side terminal 11 or the purchase side terminal 12 performs relatively simple processing, such as input or search for a product for which an advance order direct trade is performed or exchange of the information regarding an advance order trade, it does not need to be a terminal with a special function, and any kind of electronic apparatus may be used if it has general calculation function, communication function, and data display and input functions, such as a personal computer, a PDA (Personal Digital Assistant), and a mobile phone, for example.

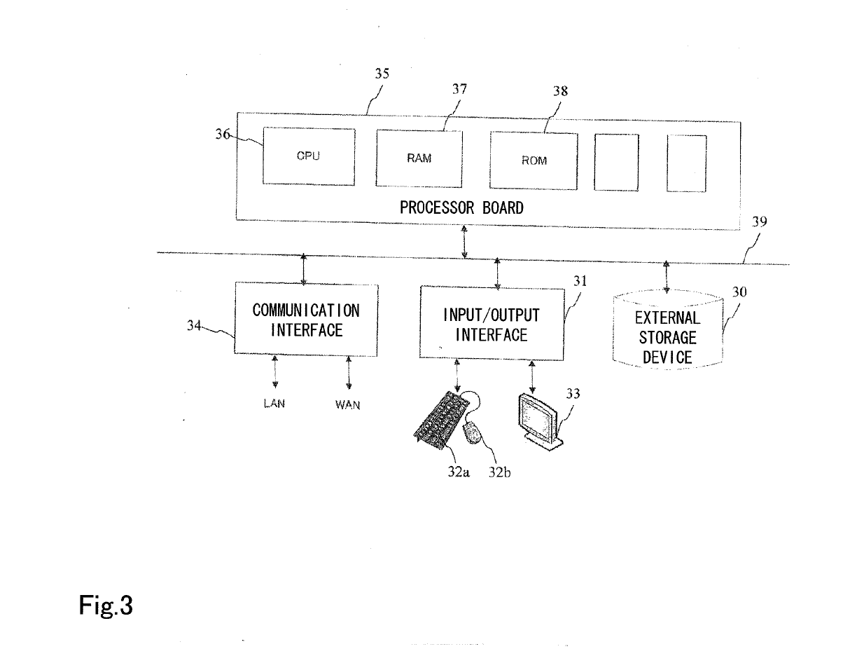

FIG. 3 is a view showing the main hardware configuration of the advance order direct trade server 10.

In the advance order direct trade server 10 of this example, an external storage device 30, an input/output interface 31 connected to a keyboard 32a, a mouse 32b, a display (screen) 33, or the like, a communication interface 34 connected to a LAN, a WAN, or the like, and a processor board 35 having a CPU 36, a RAM 37, a ROM 38, and the like are connected to each other through a system bus 39.

In FIG. 3, a program or data for realizing an advance order direct trade by appropriately mediating a buyer or a seller is stored in the external storage device 30 which is formed by a hard disk, a magneto-optical disk, a semiconductor memory, or the like. The input/output interface 31 is a device for making it possible to use devices which perform inputting and outputting, such as the mouse 32b or the keyboard 32a which is an example of an input device and the display 33 which is an example of an output device. The communication interface 34 is a device for connecting the advance order direct trade server 10 to the communication network. The processor board 35 is a device for performing information processing in the advance order direct trade server 10 and includes components, such as the CPU 36 for performing computation, the RAM 37 for temporary storage, and the ROM 38 for storing a program and the like.

The external storage device 30, the input/output interface 31, the communication interface 34, and the processor board 35 are connected to each other by the system bus 39 to operate. In the advance order direct trade server 10, complicated processing for performing advance order direct trading of tradable products of a seller, which are difficult to estimate in advance, appropriately according to the purchase needs of a buyer is performed. Accordingly, even if it does not need to be an apparatus with a special function, a computer with computation capability equal to or higher than a certain level, for example, an electronic apparatus such as a personal computer or a workstation is suitable.

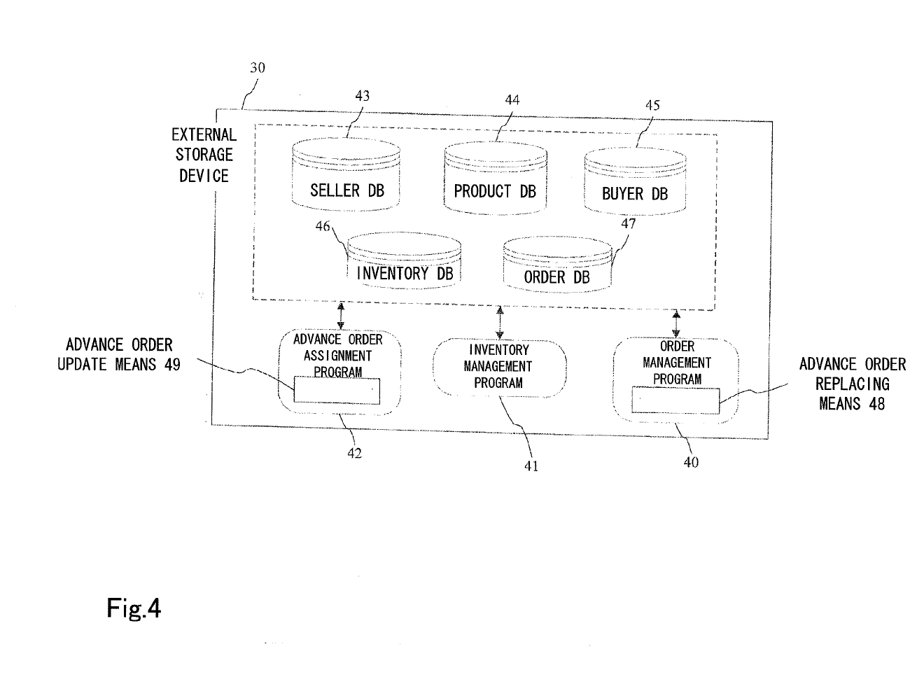

FIG. 4 is a view showing a program stored in the external storage device 30 of the advance order direct trade server 10 and the configuration of a database.

In this example, an order management program 40 having an advance order replacing means 48, an inventory management program 41, and an advance order assignment program 42 having an advance order update means 49 are stored in the external storage device 30. In addition, a seller DB 43, a product DB 44, a buyer DB 45, an inventory DB 46, and an order DB 47 are stored in the external storage device 30 as a database (DB).

The order management program 40 is a program for receiving an order for a product, which is registered in the product DB 44, of a seller, which is registered in the seller DB 43, from a buyer registered in the buyer DB 45 through the buyer terminal 12 and for registering it in the order DB 47 after processing it. The inventory management program 41 is a program used when a seller registered in the seller DB 43 registers the inventory information of products, which are registered in the product DB 44, in the inventory DB 46 to update it. In addition, the advance order assignment program 42 is a program for assigning products to an advance order, which is registered in the order DB 47, when the inventory level is registered in the inventory DB 46.

When a large-scale vendor such as a supermarket places an order for vegetables and fruit, seafood, and the like in order to purchase the products, it is preferable to reliably purchase a required amount of products by setting candidates of purchasable products in plural numbers rather than having a possibility that products will be insufficient according to the shipping situation of the purchase day by limiting the purchase to products from the specific place of production or products of specific items. Moreover, in a restaurant and the like, purchasing of products related to the specific place of production or a specific item is requested for in many cases. In the order management program 40, the advance order replacing means 48 replaces products reserved as one candidate previously by a supermarket, for example, with products of other order candidates on the basis of a difference in values of buyers regarding the products to order so that, for example, a restaurant which wants to purchase only specific products can place an order for the products.

In an advance order direct trade of perishable products, such as vegetables and fruits or seafood, it is not decided in advance what amount of products can be actually secured as an inventory on a date of sales. Therefore, there were problems in that a buyer could not place an appropriate order for the required amount of products and a seller could not expect an order just enough for products that could be prepared. Since the advance order assignment program 42 has the advance order update means 49 for appropriately assigning an order from a buyer to a seller according to the inventory at the time of a trade, the above-described problem is solved.

Hereinafter, a database structure or details of a program when an advance order direct trade of seafood is assumed will be specifically described. The database structure or a program shown below is an example when an advance order direct trade regarding seafood is assumed. When it is applied for advance order direct trade of vegetables and fruit other than seafood, it operates without a problem like the case of advance order direct trade of seafood as a system by appropriately changing a table name, a field name, and the like.

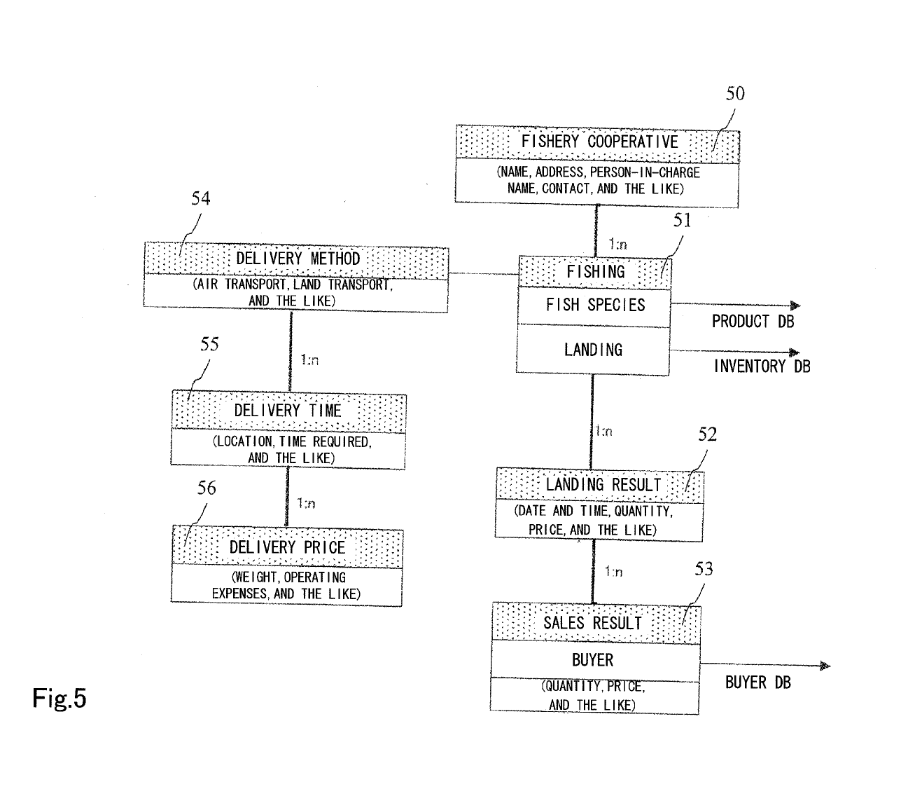

FIG. 5 is a view showing a specific data structure when an advance order direct trade regarding seafood of the seller DB 43 stored in the external storage device 30 of the advance order direct trade server 10 is assumed.

First, a fishery cooperative table 50 is data indicating the facts of a seller, and the information is registered in fields, such as a name, an address, a name of a person in charge, and a contact, as the attributes. For each fishing port record registered in the fishery cooperative table 50, the product information on a trade date is stored in a fishing table 51. The fishing table 51 has a fish species field indicating products and a landing field indicating the inventory status, and the specific information is registered in the product DB 44 and the inventory DB 46. For each fishing record registered in the fishing table 51, the past inventory status before the trade date is stored in a landing result table 52. As attributes of the landing result table 52, the information is registered in fields such as date and time, quantity, and a price.

In addition, for each landing result record registered in the landing result table 52, a sales result is stored in a sales result table 53. In the sales result table 53, the information is registered in a buyer field indicating a buyer who purchased products and a field for other quantity and a price. In addition, a delivery method table 54 which stores the data regarding the delivery of products exists for each fishing table 51. The delivery method table 54 has a field where a transport method is described, and the information regarding a transport means, such as air transport or land transport, is registered. For each delivery method record registered in the delivery method table 54, the information including a time required according to the main delivery locations is registered in a delivery time table 55. Moreover, for each delivery time record registered in the delivery time table 55, the information including the operating expenses based on the weight of products delivered is registered in a delivery price table 56.

Here, in FIG. 5, “1: n” indicates that a plurality of low levels may exist for one high level. In addition, although the same character “n” is used in all places for convenience of explanation, it may be any value.

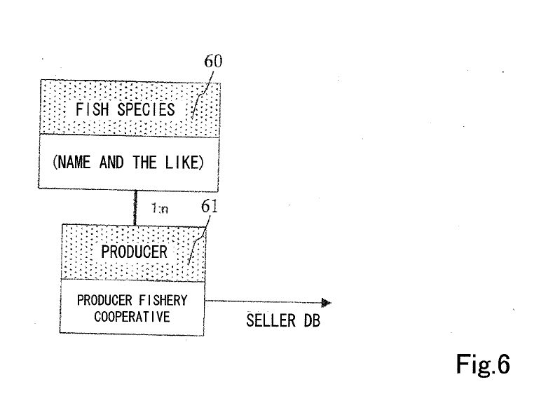

In addition, the same is true for “1: n” in FIGS. 6 to 9.

FIG. 6 is a view showing a specific data structure when an advance order direct trade regarding seafood of the product DB 44 stored in the external storage device 30 of the advance order direct trade server 10 is assumed.

First, in a fish species table 60, the information is registered in a field, such as a name, as information regarding products. For each fish species record registered in the fish species table 60, the producer information is stored in a producer table 61, and the information is registered in a fishery cooperative field. Here, the specific information regarding each fishery cooperative is registered in the seller DB 43.

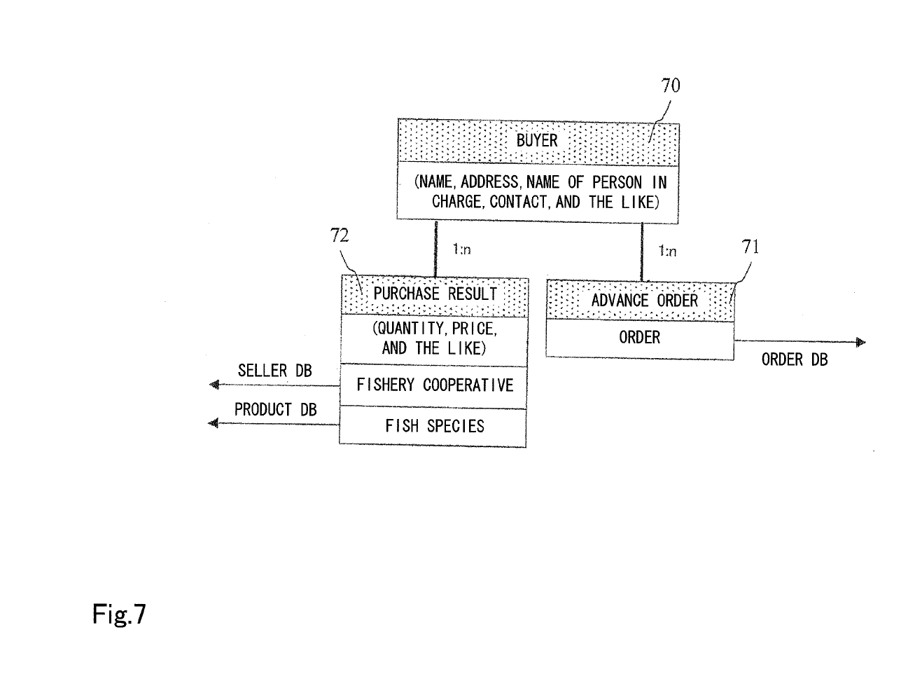

FIG. 7 is a view showing a specific data structure when an advance order direct trade regarding seafood of the buyer DB 45 stored in the external storage device 30 of the advance order direct trade server 10 is assumed.

A buyer table 70 is data indicating the facts of a buyer, and the information is registered in fields, such as a name, an address, a name of a person in charge, and a contact, as the attributes. For each buyer record registered in the buyer table 70, the information regarding the order on a trade date is stored in an advance order table 71. The advance order table 71 has an order field indicating the order state for landing on a trade date, and the specific information is registered in the order DB 47. In addition, the past purchase record information regarding each buyer record registered in the buyer table 70 is stored in a purchase result table 72. The purchase result table 72 has a field indicating the information, such as the quantity and a price, or a field indicating the information regarding a fishery cooperative, through which trading was conducted, and fish species traded. The specific information regarding the fishery cooperative, through which trading was conducted, or the fish species traded is stored in the seller DB 43 and the product DB 44.

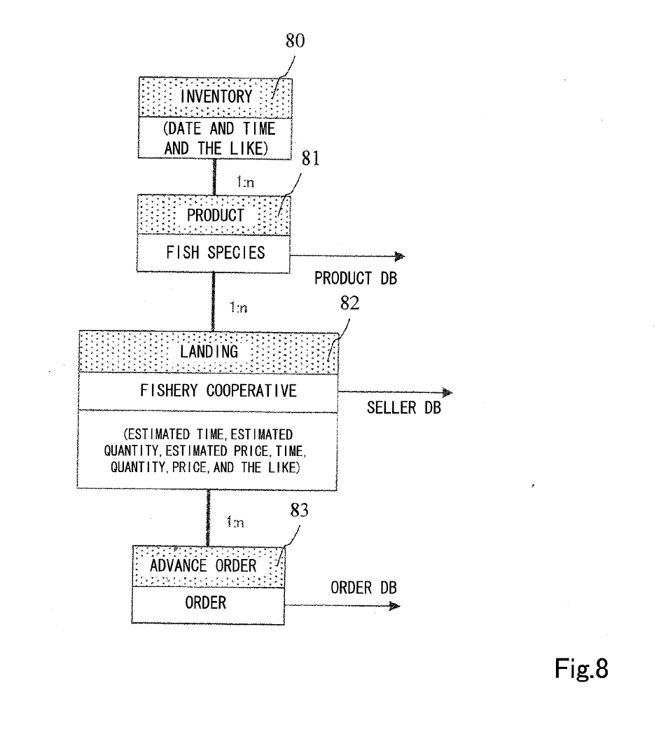

FIG. 8 is a view showing a specific data structure when an advance order direct trade regarding seafood of the inventory DB 46 stored in the external storage device 30 of the advance order direct trade server 10 is assumed.

Since the inventory table 80 is information indicating the inventory status of products on a trade date, the information is registered in a field, such as a time. In each inventory record registered in the inventory table 80, the product information in the inventory is registered in a product table 81. The product table 81 has a fish species field indicating an object for trade, and the specific information is stored in the product DB 44. For each product record registered in the product table 81, the landing information on a trade date is stored in a landing table 82. The landing table 82 has not only a fishery cooperative field indicating a fishery cooperative which landed the products but also a field indicating the information regarding landing, such as result values or estimated values regarding a time, quantity, a price, and the like, and the information is registered. In addition, for each landing record registered in the landing table 82, the order information regarding the landing is stored in an advance order table 83. The advance order table 83 has an order field in which the order information for landing is registered. Here, the specific information regarding each order is registered in the order DB 47.

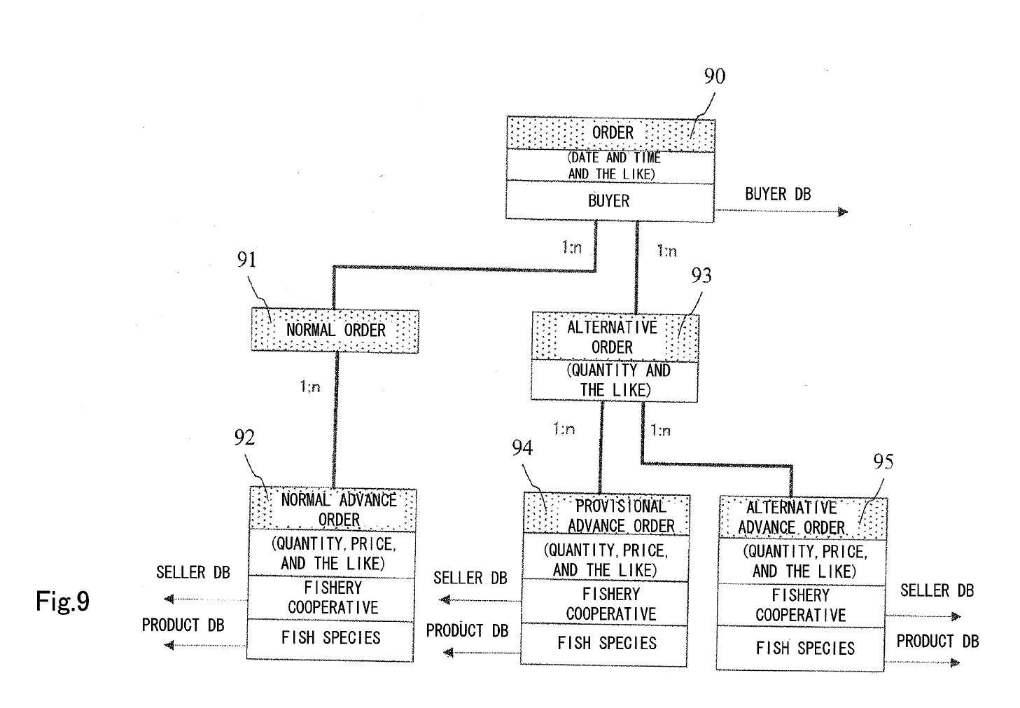

FIG. 9 is a view showing a specific data structure when an advance order direct trade regarding seafood of the order DB 47 stored in the external storage device 30 of the advance order direct trade server 10 is assumed.

The order table 90 is data indicating the order information from each buyer on a specific trade date and has a field where the information, such as date and time, is stored, and a buyer field where the information regarding a buyer is stored. Here, the specific information regarding a buyer is registered in the buyer DB 45.

Regarding a normal order for which there is no alternative among orders, the information is registered in a normal order table 91. In the case of a normal order, there is no trade when an inventory satisfying the order conditions on a trade date is not prepared. For each normal order record, the order information is registered in a normal advance order table 92. The normal advance order table 92 has a field where the information, such as the quantity and a price, is registered or a field where a counterparty fishery cooperative or fish species traded is registered. Here, the specific information regarding a fishery cooperative is registered in the seller DB 43, and the specific information regarding fish species is registered in the product DB 44.

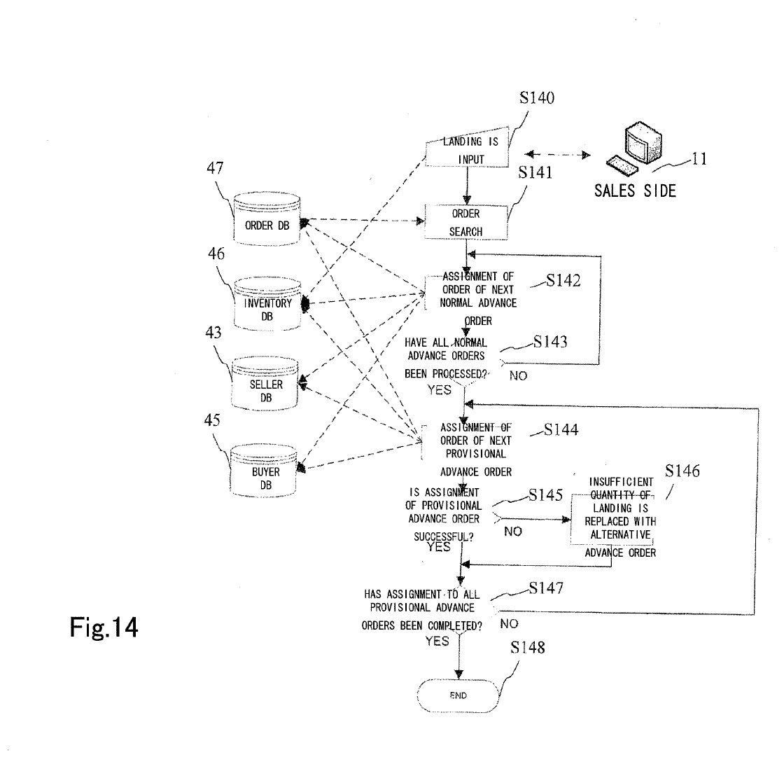

In addition, regarding an order for which there is an alternative among orders, the information is registered in an alternative order table 93. In the case of an alternative order, when an alternative advance order was designated in advance for an advance order for which an inventory satisfying the order conditions was not prepared on a trade date, an advance order for which there was no trade may be replaced with another advance order. A specific procedure for that will be described later using FIG. 14. The alternative order table has a field where the information such as order quantity as a total of advance order for which there is an alternative is registered. Aprovisional advance order table 94, in which the information regarding high-priority multiple order candidates is stored, and an alternative advance order table 95, in which the information regarding multiple order candidates as alternatives when an order provisionally reserved is not approved is stored, are registered in each alternative order record registered in the alternative order table 93. Each of the provisional advance order table 94 and the alternative advance order table 95 has a field indicating the information, such as the quantity and a price, or a field indicating the information regarding a fishery cooperative or fish species, similar to the normal advance order table 92.

On the basis of the content of five databases described in FIGS. 5 to 9, a specific procedure in one form when executing the present invention will be described below with reference to drawings.

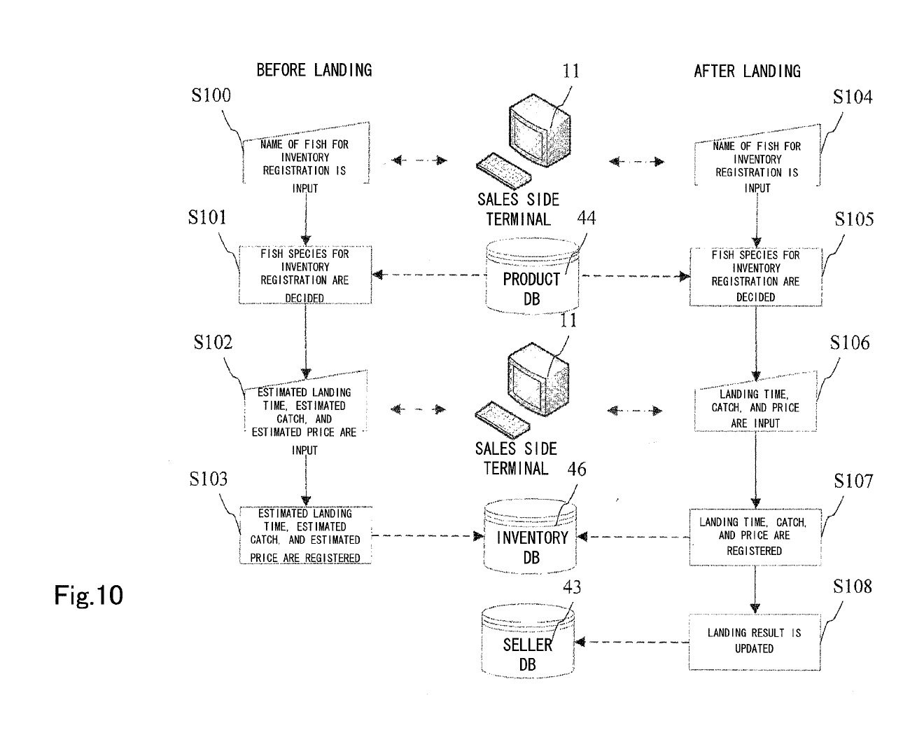

FIG. 10 shows a procedure when a fishery cooperative, which is a seller, registers an inventory status of products as information in the inventory DB 46, which is stored in the external storage device 30 of the advance order direct trade server 10, when executing the present embodiment.

First, a fishery cooperative registers names of seafood, for which inventory registration is performed, using the seller terminal 11 in a state before the seafood are actually landed (step S100). By searching for the fish species table 60 of the product DB 44 using the input names of seafood, fish species for which inventory registration is performed are decided (step S101). In addition, the fishery cooperative inputs an estimated landing time, an estimated catch, and an estimated price of the fish species on a trade date using the sales side terminal 11 (step S102), and these values are registered in the inventory DB 46 (step S103).

Since a timing at which a buyer places a purchase order is before landing on a trade date is performed, an order is placed on the basis of such information registered in the inventory DB 46. Then, in a state after the seafood was actually landed, the fishery cooperative inputs names of the seafood for which inventory registration is performed using the sales side terminal 11 (step S104), and decides the fish species for which inventory registration is performed by searching for the fish species table 60 of the product DB 44 (step S105). Then, the fishery cooperative inputs actual landing time, catch, and selling price on a trade date using the sales side terminal 11 (step S106), and registers them in the product DB 46 (step S107) and also updates the content of the landing result table 52 of the seller DB 43 (step S108). In this way, the product information used when a buyer places an order in an advance order direct trade and the product information used when actually assigning buyer products are registered in the product DB 46.

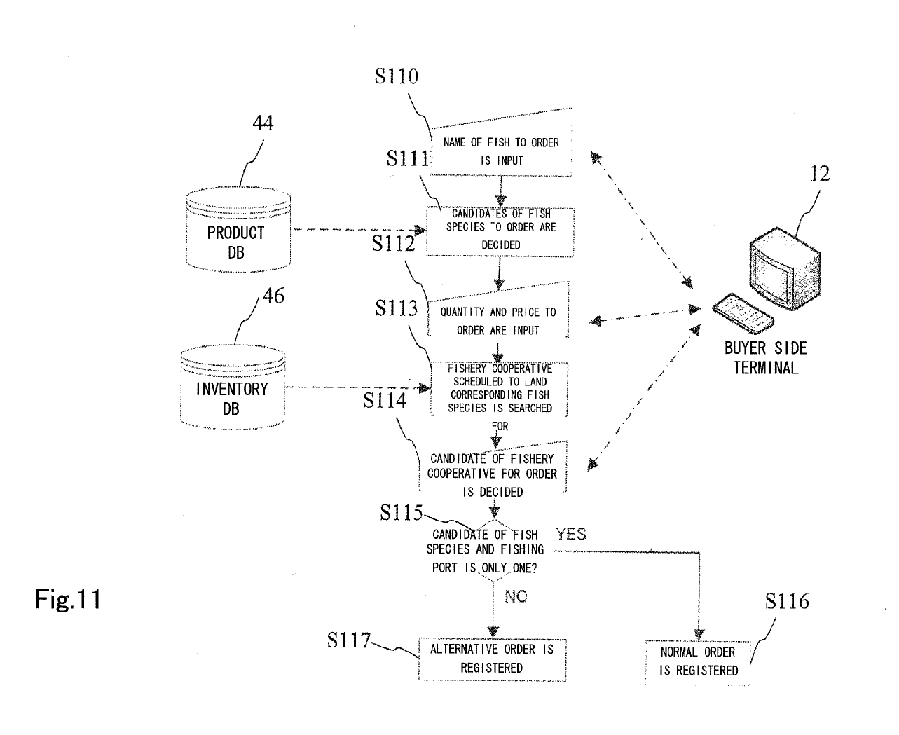

FIG. 11 shows a procedure when a buyer registers a product order as information in the order DB 47, which is stored in the external storage device 30 of the advance order direct trade server 10, when executing the present embodiment.

First, a buyer inputs names of seafood to order using the purchase side terminal 12 (step S110), and searches for the fish species table 60 registered in the product DB 44 and decides a fish species to order (step S111). By repeating steps S110 and S111, it is also possible to designate a plurality of fish species as alternatives and place an alternative order in step S117.

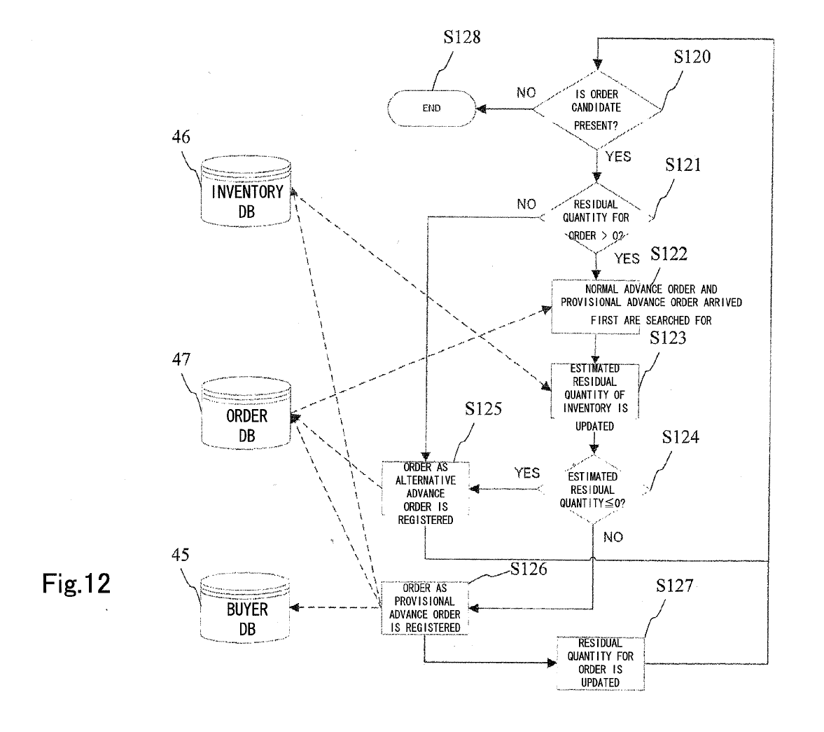

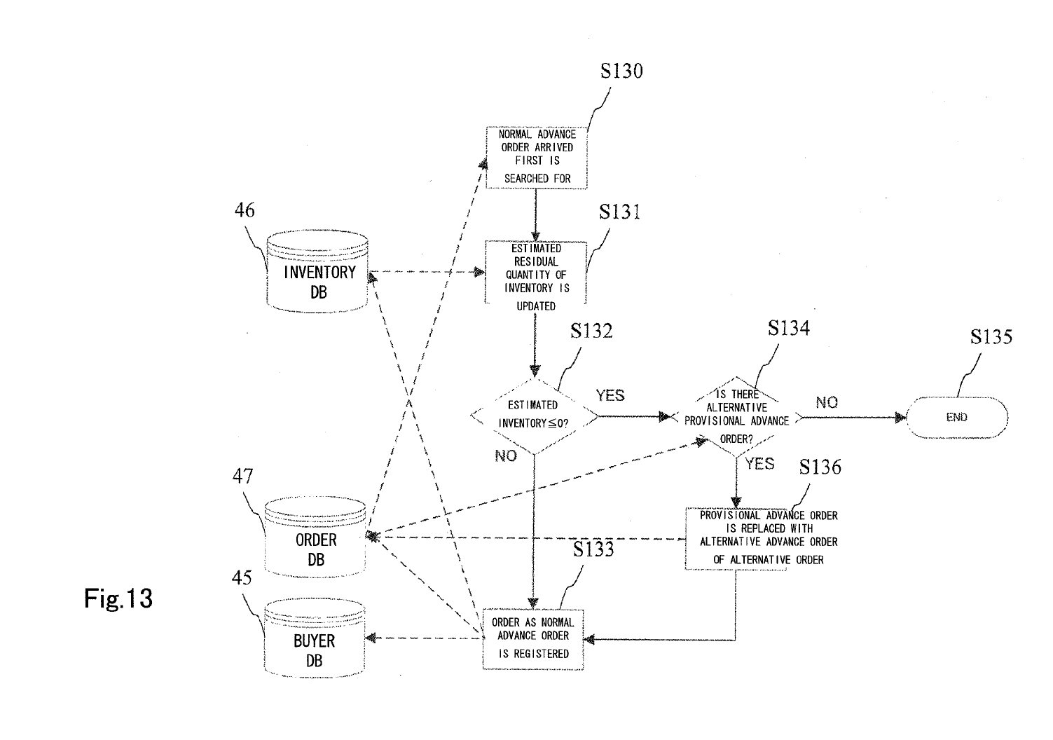

After deciding the fish species, the buyer inputs the order quantity of the fish species and its desired price with the purchase side terminal 12 (step S112). By checking the content, such as an estimated catch or an estimated price, of the landing table 82 of the inventory DB 46, using the information regarding the input fish species, quantity, and price, a seller, that is, a fishery cooperative satisfying the conditions of the buyer is searched for (step S113), and the buyer gives an instruction regarding a fishery cooperative, to which an order is to be actually placed, using the purchase side terminal 12 (step S114). Here, if a fish species designated as an object to order by the buyer or a fishery cooperative designated as an order destination can be uniquely decided (step S115), the order is processed as a normal order (step S116). If a fish species to order is designated as a plurality of candidates or a plurality of candidates regarding a fishery cooperative, to which an order is to be placed, is designated (step S115), it is processed as an alternative order with each of the orders as an order candidate (step S117). The processing functions of these steps S116 and S117 are equivalent to the advance order replacing means 48. Among the functions of the advance order replacing means 48, processing regarding an alternative order will be described using FIG. 12 and processing regarding a normal order will be described using FIG. 13.

FIG. 12 shows a processing procedure when an alternative order record is registered in the order DB 47, which is stored in the external storage device 30 of the advance order direct trade server 10 when a buyer places an alternative order, when executing the present embodiment.

Since an alternative order includes a plurality of order candidates for a plurality of fish species or fishery cooperatives, the following processing is repeatedly performed until all the order candidates are registered (step S120). Here, regarding the order in which order candidates are processed, an order based on an estimated landing time or the like is thought to be appropriate. However, an order based on the priority set by the buyer is also possible.

First, the residual quantity for the order calculated from the order quantity registered in the alternative order table 93 is checked (step S121). If the residual quantity for the order is already equal to or smaller than 0, all subsequent orders are processed as alternative advance orders (step S125). If the residual quantity for the order still remains, a record with a combination of the same fish species and fishery cooperative is searched from the normal advance order table 92 and the provisional advance order table 94, which are already registered in the order DB 47, for a combination of fish species and fishery cooperatives registered in order candidates (step S122). Moreover, for a combination of fish species and fishery cooperatives registered in the order candidates, a record with a combination of the same fish species and fishery cooperative is searched from the landing table 82 registered in the inventory DB 46. A value obtained by subtracting the sum of the quantities of the normal advance order record and the provisional advance order record searched previously from the estimated catch is updated as an estimated inventory level (step S123). According to whether or not the updated estimated inventory level is larger than 0, it is determined whether the order candidate is registered as a provisional advance order or registered as an alternative advance order (step S124).

If the estimated inventory level is equal to or smaller than 0, the order candidate is registered in the alternative advance order table 95 of the order DB 47 as an alternative advance order (step S125). If the estimated inventory level is larger than 0, the order candidate is registered in the provisional advance order table 94 of the order DB 47 as a provisional advance order, and the information is also registered in the order field of the advance order table 71 of the buyer DB 45 or in the order field of the advance order table 83 of the inventory DB 46 (step S126). In addition, the residual quantity for the order as an alternative order is updated by subtracting the provisionally reserved quantity from it (step S127). After all order candidates are processed to be registered as provisional advance orders or alternative advance orders, the alternative order registration ends (step S128). Sellers, such as a fishery cooperative, can check in advance how many advance orders have been made compared with a catch by checking the order field registered in the advance order table 83 of the inventory DB 46. When alternative advance orders are registered exceeding the estimated catch, a profit can be increased by examining a catch increase by performing fishing more than planned.

FIG. 13 shows a processing procedure when a normal order record is registered in the order DB 47, which is stored in the external storage device 30 of the advance order direct trade server 10 when a buyer places a normal order, when executing the present embodiment.

Since the normal order has only one order candidate, repeated processing is not necessary unlike the alternative order, and a record with a combination of the same fish species and fishery cooperative is searched from the normal advance order table 92, which is already registered in the order DB 47, for a combination of fish species and fishery cooperatives registered (step S130). Moreover, for a combination of fish species and fishery cooperatives registered in the order, a record with a combination of the same fish species and fishery cooperative is searched from the landing table 82 registered in the inventory DB 46. A value obtained by subtracting the quantity of the normal advance order record searched previously from the estimated catch is updated as an estimated inventory level (step S131). According to whether or not the updated estimated inventory level is larger than 0, it is determined whether or not the order can be registered as a normal advance order without replacement (step S132).

Since the order can be registered as a normal advance order without replacement if the estimated inventory level is larger than 0, the order is registered in the normal advance order table 92 of the order DB 47 as a normal advance order, and the information is also registered in the order field of the advance order table 71 of the buyer DB 45 or in the order field of the advance order table 83 of the inventory DB 46 (step S133). If the estimated inventory level is equal to or smaller than 0, a record with a combination of the same fish species and fishery cooperative is searched from the provisional advance order table 94 and the alternative advance order table 95 registered in the order DB 47, and it is checked whether or not a provisional advance order with an alternative advance order which can replace the provisional advance order in a number equal to or larger than the order quantity exists (step S134). If a provisional advance order satisfying such conditions is not registered in the order DB 47, this order is not approved and the processing ends (step S135).

If a provisional advance order with an alternative advance order as an alternative exists in the order DB 47, a provisional advance order record is deleted from the provisional advance order table 94 and a corresponding alternative advance order is made again as a provisional advance order to move from the alternative advance order table 95 of the order DB 47 to the provisional advance order table 94 (step S136). Then, the order is registered in the normal advance order table 92 of the order DB 47 as a normal advance order, and the information is also registered in the order field of the advance order table 71 of the buyer DB 45 or in the order field of the advance order table 83 of the inventory DB 46 (step S133).

By performing such processing, a buyer who wants to place an order for a specific fish species and a specific fishery cooperative at any cost can place a desired normal order by replacing a provisional advance order of an alternative order with an alternative advance order if an alternative first-arrival order exists for the inventory even if there is no corresponding inventory. When such replacement occurs, the seller can perform charging based on the value of the specific fishery cooperative and fish species for the buyer by imposing a surcharge on the buyer.

FIG. 14 shows a processing procedure when a landing result on a trade date is registered for a landing record of the inventory DB 46, which is stored in the external storage device 30 of the advance order direct trade server 10 by the fishery cooperative that is a seller, and the landing is assigned to the order registered in the order DB 47, when executing the present embodiment.

First, a fishery cooperative updates a landing record, which is registered in the landing table 82 of the inventory DB 46, regarding the information including the quantity or a price for every fish species that is data of a landing result on a trade date using the sales side terminal 11 (step S140). The order information for the fishery cooperative is searched from the order DB 47 using the information registered in the advance order table of the updated landing record (step S141). First, a normal advance order record of a normal order is extracted from the searched order records, and the quantity and a price of the landing record registered in the landing table 82 of the inventory DB 46 are checked. If they satisfy the conditions, advance order assignment is performed and the information regarding the inventory DB 46, the seller DB 43, the buyer DB 45, and the order DB 47 is updated. Particularly for the inventory DB 46, it is necessary to perform processing of subtracting the amount assigned for the order from the quantity registered in the landing record. If there are conditions which are not satisfied, the order of the normal advance order record fails (step S142). This is executed until an unprocessed normal advance order record does not exist for a normal order (step S143).

After processing for a normal order ends, processing for an alternative order is performed. First, a provisional advance order record of an alternative order is extracted from the order records searched in step S141 to try advance order assignment, and the quantity and a price of the landing record registered in the landing table 82 of the inventory DB 46 are checked. If they satisfy the conditions, advance order assignment is performed and the information regarding the inventory DB 46, the seller DB 43, the buyer DB 45, and the order DB 47 is updated (step S144). Particularly for the inventory DB 46, it is necessary to perform processing of subtracting the amount assigned for the order from the quantity registered in the landing record.

If the conditions are not satisfied due to insufficient quantity or the like (step S145), replacement of an advance order candidate is performed by deleting the provisional advance order record and changing one of alternative advance orders, which are registered in the alternative order table 93, to a provisional advance order for an order for the quantity of insufficient landing (step S146). This is executed until an unprocessed provisional advance order record does not exist for an alternative order (step S147). The processing ends when an unprocessed provisional advance order record does not exist (step S148).

Here, the processing functions of steps S145 and S146 among these steps are equivalent to the advance order update means 49. By performing the above processing, even when landing of a specific fish species in a specific fishery cooperative is insufficient for reasons such as weather on a trade date, it is automatically replaced with orders of other fishery cooperatives or other fish species if an alternative advance order is registered as an alternative order. Accordingly, a possibility that seafood of the amount and kind reserved by direct order by the buyer will be traded safely increases.

### More Specific Example

Hereinafter, one mounting example of a fishery product advance order direct trading system, which uses the Internet, regarding the embodiment of the present invention will be described using the drawings.

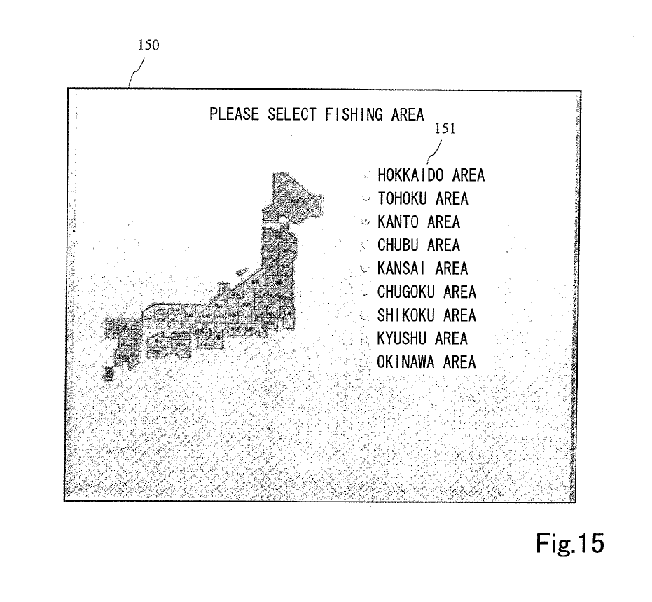

FIG. 15 shows a fishery cooperative area selection screen 150 in order processing using the purchase side terminal 12. A buyer specifies the geographical scope of a fishery cooperative for an order of products by pressing an area selection button 151 on the fishery cooperative area selection screen 150. The buyer can execute an advance order direct trade with a fishery cooperative in a specific area. Not only one area but also a plurality of areas may be selected. The buyer's burden of selecting a fishery cooperative can be reduced by filtering the number of fishery cooperatives, which are selected by subsequent processing, through this screen.

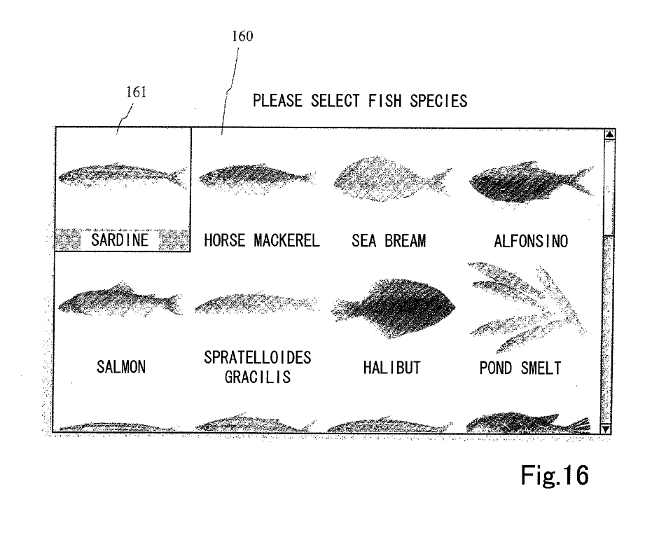

FIG. 16 shows a fish species selection screen 160 in order processing using the purchase side terminal 12. A buyer designates a fish species to order by pressing a fish species selection panel 161 on the fish species selection screen 160. For a fish species, it is also possible to designate a plurality of fish species as an alternative order.

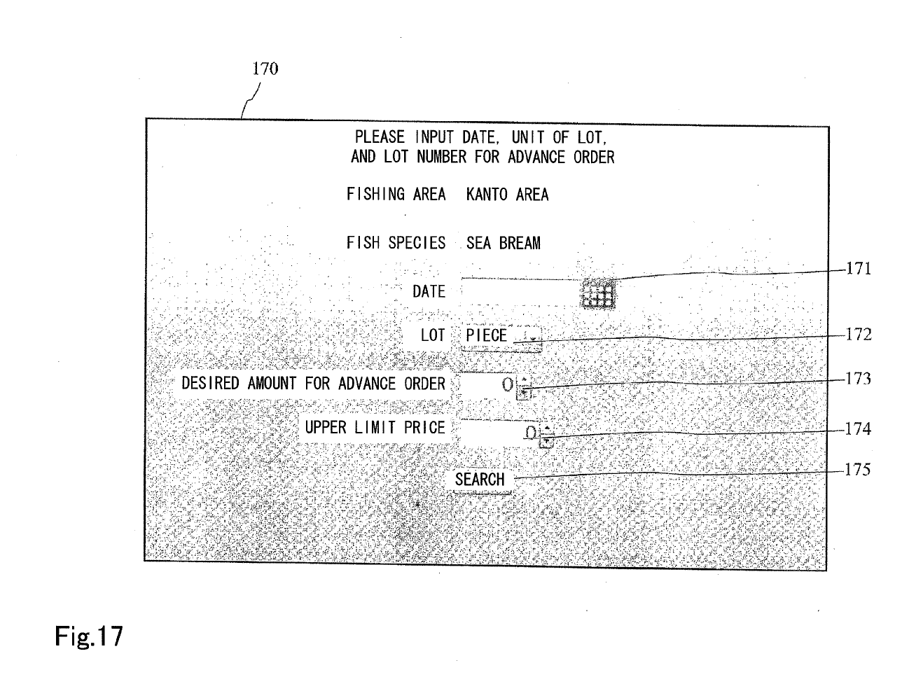

FIG. 17 shows an order input screen 170 in order processing using the purchase side terminal 12. A buyer inputs details of an order for every fish species to order using the order input screen 170. The buyer designates a schedule for an advance order direct trade using a calendar in a trade date designation column 171 and selects an appropriate thing, such as case, kg, and piece, as a trading unit in a lot column 172. In addition, the buyer designates the quantity ordered in an advance order direct trade in a desired advance order amount column 173 and designates a tradable maximum price in an upper limit price column 174. If the information input on the screens in FIGS. 15 to 17 is registered in the order DB 47 and a search button 175 is pressed, a fishery cooperative which satisfies the conditions is searched for using the data, such as an estimated quantity or an estimated price, of the landing table 82 registered in the inventory DB 46.

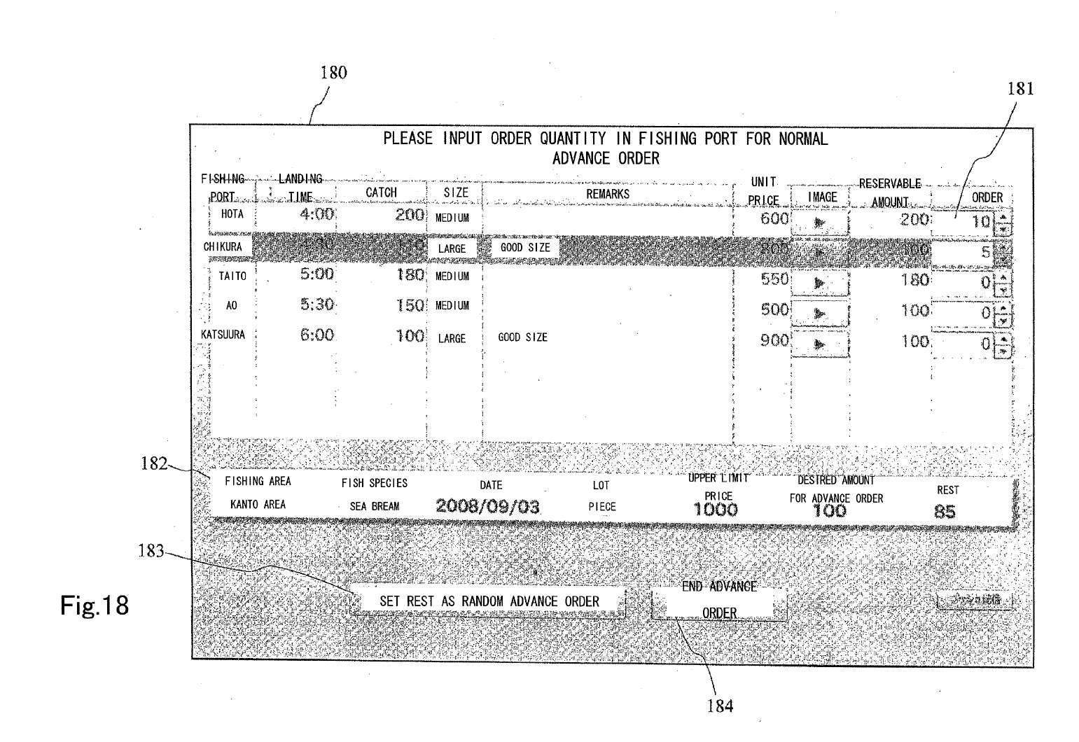

FIG. 18 shows a fishery cooperative order screen 180 in order processing using the purchase side terminal 12. A buyer inputs the volume of orders placed to a fishery cooperative for every fish species to order using the fishery cooperative order screen 180. Estimated data regarding the landing of fish species of a fishery cooperative sorted in order of estimated landing time is displayed on the fishery cooperative order screen 180 and the buyer inputs the volume of orders, which is normally reserved, in an order column 181 for every fishery cooperative. The buyer can check what amount of products compared with a desired order quantity have been normally reserved for a fishery cooperative by observing an order state display section 182. Particularly when the buyer determines that the rest volume of orders may be met from any fishery cooperative, an alternative order is placed for other fishery cooperatives displayed on the fishery cooperative order screen 180 by pressing a random advance order button 183. If the volume of orders placed to a fishery cooperative is decided, the buyer presses an advance order end button 184 to confirm the advance order.

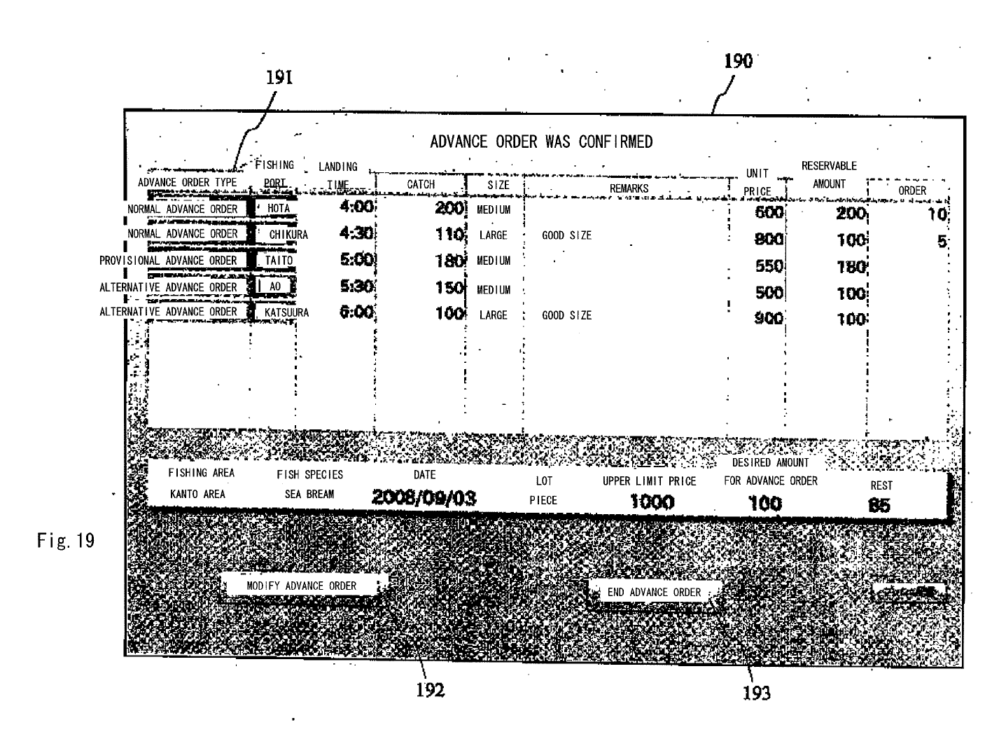

FIG. 19 shows an advance order confirmation screen 190 in order processing using the purchase side terminal 12. The content that a buyer ordered for every fishery cooperative using the fishery cooperative order screen 180 is displayed in an advance order confirmation column 191. A fishery cooperative normally reserved as a normal order and a fishery cooperative alternatively reserved or provisionally reserved as an alternative order are displayed in the advance order confirmation column 191. Here, fishery cooperatives of Hota and Chikura are registered as normal advance order, a Taito fishery cooperative is registered as a provisional advance order, and fishery cooperatives of Ao and Katsuura are registered as alternative advance orders. Accordingly, even if the Taito fishery cooperative has a poor catch on a trade date due to a storm or the like, a buyer can purchase the amount of products that he or she wanted in the advance order if there is a landing in a fishery cooperative of Ao or Katsuura. The buyer checks the advance order confirmation column 191 and presses a modification button 192 if the buyer wants to modify the content and presses an advance order end button 193 if there is no problem in the content. If the modification button 192 is pressed, the screen returns to the fishery cooperative order screen 180 so that the volume of orders placed to a fishery cooperative can be modified. If the advance order end button 193 is pressed, the order content is confirmed and the content of the order DB 47 in the external storage device 30 of the advance order direct trade server 10 is updated. Thus, the buyer can register an order in the advance order direct trade server 10.

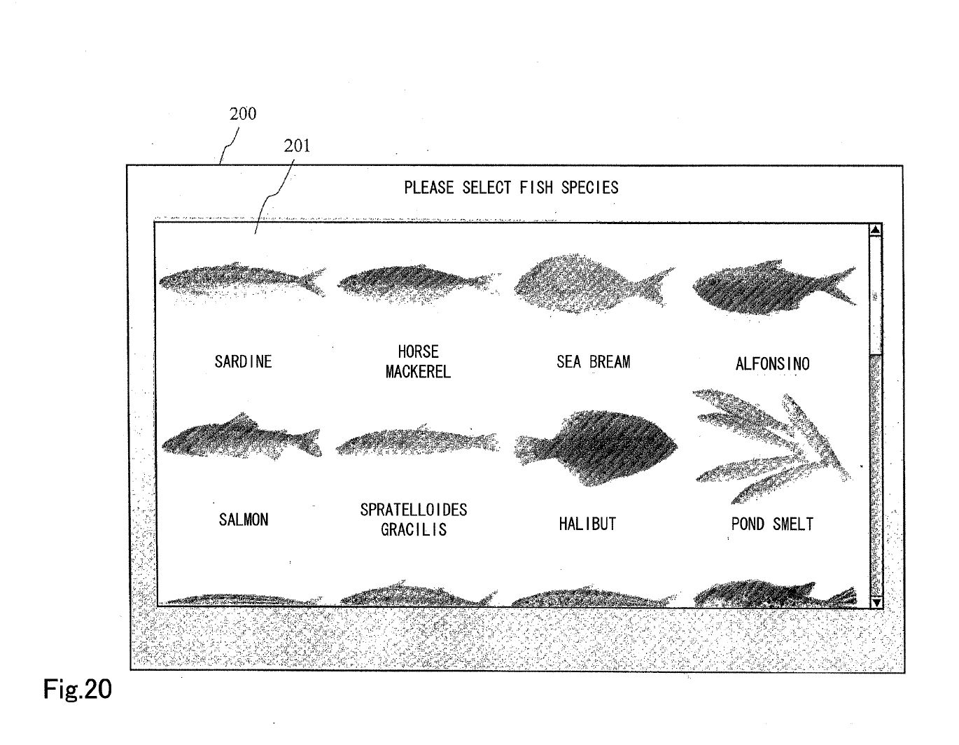

FIG. 20 shows a fish species selection screen 200 in order reception processing using the sales side terminal 11. A fishery cooperative which is a seller designates a fish species to land by pressing a fish species selection panel 201 on the fish species selection screen 200.

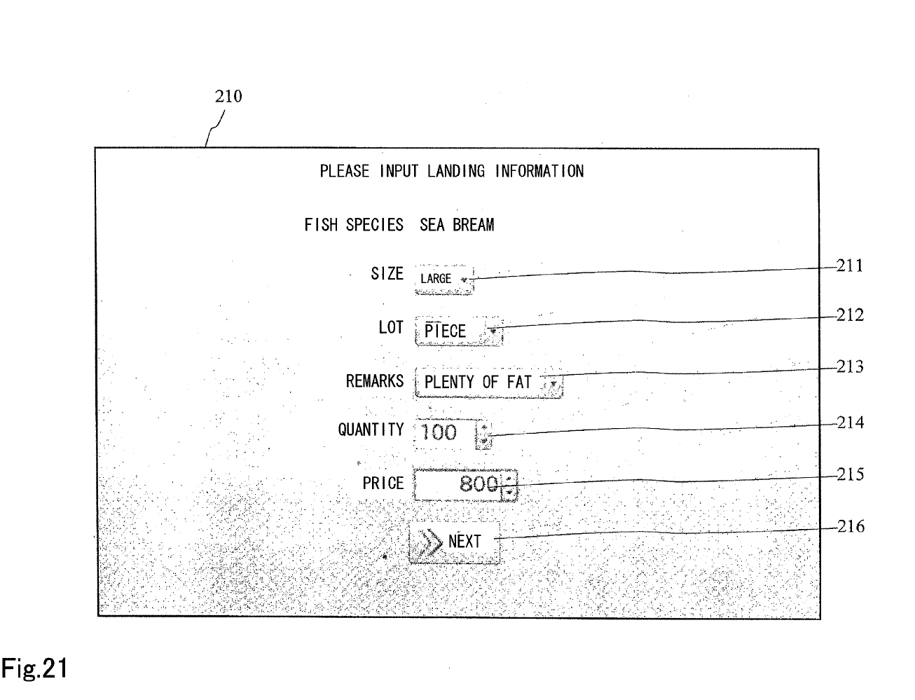

FIG. 21 shows a landing information input screen 210 in order reception processing using the sales side terminal 11. A fishery cooperative inputs the landing information for every fish species landed using the landing information input screen 210. The fishery cooperative inputs the size of seafood landed in a size column 211 and selects an appropriate thing, such as case, kg, and piece, as a trading unit in a lot column 212. In addition, the characteristics of landed seafood can be described in a remarks column 213, and a catch of fish landed can be set in a quantity column 214 and a price for the landed catch can be set in a unit price column 215. By pressing a transition button 216 after inputting the above information, the landing information of the fishery cooperative is registered in the inventory DB 46 in the external storage device 30 of the advance order direct trade server 10.

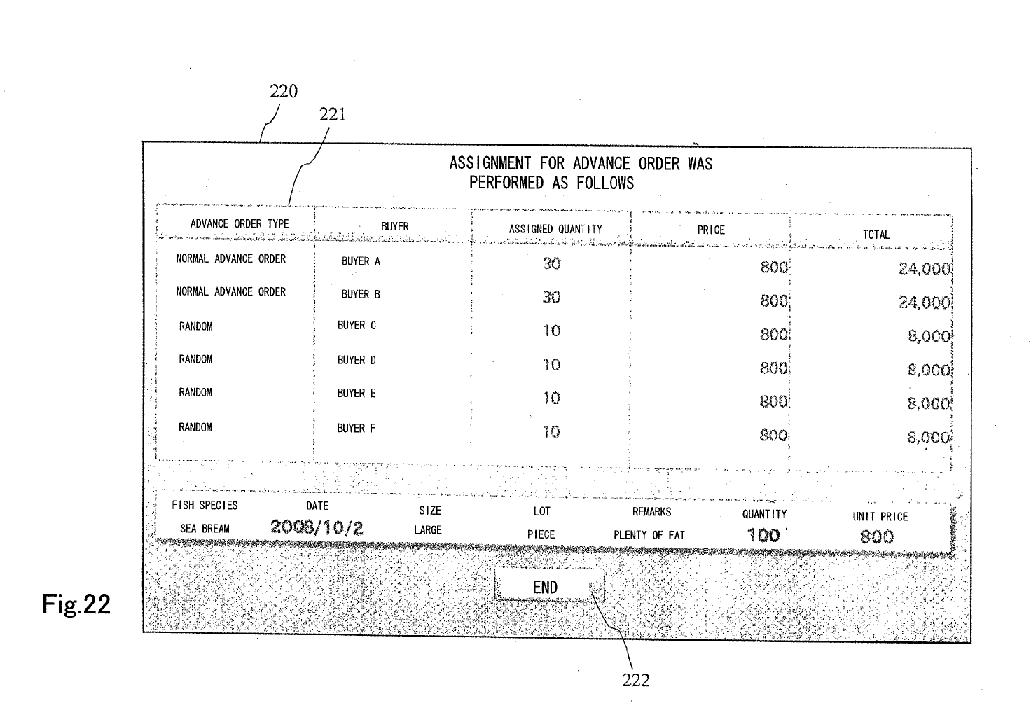

FIG. 22 shows an advance order assignment confirmation screen 220 in order reception processing using the sales side terminal 11. If the landing information is registered by the fishery cooperative, the advance order direct trade server 10 combines the information registered in the order DB 47 and the inventory DB 46 in the external storage device 30 of the advance order direct trade server 10, assigns the landed seafood to a buyer who reserved it as a normal order or an alternative order, and displays the result in an advance order assignment result column 221. If the fishery cooperative presses an end button 222 after checking the advance order assignment result, the information of the purchase result table 72 and the sales result table 53 of the seller DB 43 and the buyer DB 45 in the external storage device 30 of the advance order direct trade server 10 is updated. Thus, the fishery cooperative which is a seller can assign seafood landed on a trade date for an advance order from a buyer registered in the advance order direct trade server 10.

### SUMMARY

Although one embodiment of the present invention has been described, the present invention is not limited to the above embodiment and various configurations, aspects, and the like may also be used. Therefore, the outline of the present invention will be described below.

[1] Each advance order will be described.

(1) In a normal advance order (normal order), parameters such as a fish species or a fishery cooperative, are fixedly set.

(2) An alternative advance order (alternative order) includes a provisional advance order and an alternative advance order.

In the case of a provisional advance order, all products secured as a result are purchased. Any number of provisional advance orders may be designated and its content may be arbitrary.

The alternative advance order is an alternative when a provisional advance order is not approved. Any number of alternative advance orders may be designated and its content may also be arbitrary. When there is a plurality of alternative advance orders, their priorities are set on the basis of the order of earliness decided by a result value or, by designation of a person, for example.

As an example, if there are a plurality of fish species and the like when an alternative advance order is made by designation of a person, priorities regarding which alternative advance order is to replace a provisional advance order are set at the time of an advance order.

Moreover, as an example, if a buyer wants sardine 50 cases (amount), for example, when an alternative advance order or a candidate of the alternative advance order is decided by automatic designation of an apparatus, sardine 50 cases are input for a provisional advance order and an alternative advance order is made for more than that. In the alternative advance order, arbitrary parameters, such as a fish species or a fishery cooperative, may be changed. For example, candidates of an alternative advance order may be automatically displayed so that the alternative advance order is accepted if a buyer approves of it.

[2] The advance order replacing means 48 and the advance order update means 49 will be described.

(1) Mainly when there is a desire to put a normal advance order into the same place as provisional advance orders of other persons which are already present, the advance order replacing means 48 puts the normal advance order if the provisional advance orders of other persons can be replaced with alternative advance orders of other persons.

(2) When a result value comes out for an advance order put on the basis of the estimated value, the advance order update means 49 assigns products to the advance order on the basis of the result value. In this case, for a provisional advance order in which all or some are not approved, the provisional advance order is deleted and its alternative advance order is changed to a provisional advance order.

[3] The relationship between advance orders will be described.

First, it is basically first-come first-serve basis. Accordingly, priority is given to a person who makes an advance order early. However, there is also an exception.

(1) Regarding a normal advance order

(i) A normal advance order is not put into the place overlapping his or her own normal advance order or normal advance orders of other persons which are already present.

(ii) A normal advance order is put into the place overlapping his or her own normal advance order or normal advance orders of other persons, which are already present, by performing the replacement if the provisional advance order can be replaced with the alternative advance order. At this time, the provisional advance order is canceled and deleted, and the alternative advance order is changed to a provisional advance order as an alternative.

(iii) A normal advance order is put into the place overlapping his or her own alternative advance order or alternative advance orders of other persons which are already present. At this time, the alternative advance order is canceled and deleted.

(2) Regarding a provisional advance order

(i) A provisional advance order is not put into the place overlapping his or her own normal advance order or normal advance orders of other persons which are already present.

(ii) A provisional advance order is not put into the place overlapping his or her own provisional advance order or provisional advance orders of other persons which are already present.

(iii) A provisional advance order is put into the place overlapping his or her own alternative advance order or alternative advance orders of other persons which are already present. At this time, the alternative advance order is canceled and deleted.

(3) Regarding an alternative advance order

(i) An alternative advance order is not put into the place overlapping his or her own normal advance order or normal advance orders of other persons which are already present.

(ii) An alternative advance order is not put into the place overlapping his or her own provisional advance order or provisional advance orders of other persons which are already present.

(iii) An alternative advance order is put into the place overlapping his or her own alternative advance order or alternative advance orders of other persons which are already present. At this time, both of the alternative advance orders remain.

[4] Other matters regarding an advance order will be described.

(1) One buyer can make only a normal advance order, make only an alternative advance order, or make both a normal advance order and an alternative advance order.

(2) An advance order is made in consideration of an estimated value. For example, a normal advance order, a provisional advance order, and an alternative advance order cannot exceed an estimated value (for example, an estimated amount). However, for example, alternative advance orders of different buyers may exceed an estimated value (for example, an estimated amount) as a whole or may overlap. In addition, even if there is an inventory (estimated value), an alternative advance order may be freely made.

(3) A deadline of an advance order is before the result value comes out, for example, and may also be set arbitrarily.

[5] Processing when an advance order is confirmed will be described.

(1) Whenever each result value (for example, a result value on landing date and time of each fishery cooperative) comes out, a confirmed advance order (for example, all approved, partially approved, not approved) is set, and advance orders which were set is cancelled and deleted.

(i) For a normal advance order, products are assigned with a top priority. However, the normal advance order is canceled (not approved) if assignment is not possible. Moreover, for example, when you want 100 but there is only some (for example, 50), all are cancelled or some (for example, 50) are approved. However, the selection is decided by initial setting, setting (for example, based on communication between a seller and a buyer) on landing date and time, and the like.

(ii) In the case of a provisional advance order, basically, when you want 100 but there is only some (for example, 50), only some (for example, 50) are assigned. However, it is also possible to use a configuration of canceling all. In addition, for example, even if that part is very small (for example, in the case of 1), it may be assigned. Alternatively, if an assignable number is equal to or smaller than a predetermined threshold value (or smaller than a predetermined threshold value) set in advance (initially set or set by a buyer), it may be canceled.

(iii) An alternative advance order is for covering products insufficient in a confirmation situation of a provisional advance order corresponding to it. For example, even if products are not sufficient in a confirmation situation of a normal advance order, it is covered in an alternative advance order. As an example, when only 50 are approved in a provisional advance order of 100, alternative things (for example, 50 of the same fish species or the same number or a different number of other fish species) in an alternative advance order are changed to a provisional advance order.

The relationship between the confirmation situation (for example, some approved or not approved) of a provisional advance order and an alternative advance order changed to a provisional advance order at that time is set at the time of an advance order, for example. As a specific example, it may be automatically set by a person or an apparatus on the basis of a policy in which fish species and the number are constant and a fishery cooperative is arbitrary, for example.

In addition, depending on a result value, the alternative advance order may be approved in part or may not be approved.

(2) Example of priorities when an advance order is confirmed.

(i) When a provisional advance order and an alternative advance order are for the same fish species, for example, when a provisional advance order is 100, an alternative advance order with a highest priority is 30, an alternative advance order with a second highest priority is 15, and an alternative advance order with a third highest priority is 10, if only 50 are approved in the provisional advance order, the alternative advance order with a highest priority is regarded as 30, the alternative advance order with a second highest priority is regarded as 15, and the alternative advance order with a third highest priority is regarded as 5, and these alternative advance orders are changed to provisional advance orders. At this time, alternative advance orders of others (or itself) competing with the provisional advance orders after the change are canceled and deleted.

(ii) When a provisional advance order and an alternative advance order are for different fish species, for example, the conditions for changing the alternative advance order to a provisional advance order are set in advance at the time of an advance order. As a specific example, “six sea breams are equivalent to 100 sardines” and the like are set.

[6] The configuration examples of an apparatus and a system will be described.

In the present embodiment, in FIG. 1, the advance order processing system is formed by the advance order direct trade support system. In addition, the advance order processing apparatus is formed by the advance order direct trade server 10 and performs overall processing regarding an advance order. In addition, a terminal device operated by a person on the sales side (for example, a seller) is formed by the sales side terminals 11a and lib, and a terminal device operated by a person on the purchase side (for example, a buyer) is formed by the purchase side terminals 12a and 12b. Each of them is operated by a person (user) to perform processing regarding an advance order, and various kinds of information is communicated (transmitted or received) through a network (in the present embodiment, the communication network 13) between each of them and the advance order direct trade server 10. In addition, for example, various kinds of information used in various kinds of processing regarding an advance order are stored in a memory of an apparatus as data, for example, are associated with each other when necessary. In addition, various kinds of processing regarding an advance order are executed by an information processing function.

Here, the configurations of the system, the apparatus, and the like related to the present invention are not necessarily limited to those illustrated above, and various configurations may be used. In addition, the present invention may also be provided, for example, as a method or a way of executing the processing related to the present invention or as a program for realizing such a method or way or a recording medium which records the program. In addition, it may also be provided as various systems or apparatuses.

In addition, the application field of the present invention is not necessarily limited to those illustrated above, and the present invention may be applied to various fields.

Moreover, as various kinds of processing performed in the system, the apparatus, and the like related to the present invention, for example, it is also possible to use a configuration controlled by making a processor execute a control program stored in a ROM in hardware resources including the processor, a memory, and the like. In addition, for example, each functional means for executing the processing may be configured as an independent hardware circuit.

In addition, the present invention may also be regarded as a computer-readable recording medium, such as a floppy (registered trademark) disc or a CD (Compact Disc)-ROM in which the above-described control program is stored, or as the program (itself). By loading the control program into the computer from the recording medium and making the processor execute it, the processing related to the present invention can be executed.

### INDUSTRIAL APPLICABILITY

In the above embodiment, an example of an advance order direct trade of fishery products was used for explanation. However, the present invention is not limited to the fishery products and may be widely applied when selling or purchasing, by advance order, products crop yields of which change depending on the weather or the like, such as agricultural products including vegetables and fruit or flowers. By using the present invention, stable purchase can be realized for a buyer without being influenced by the weather or the like, and a stable sales channel to buyers other than an auction market, in which the price greatly varies depending on the harvest of the day, can be secured for a seller. Therefore, the present invention can be used for an advance order direct trade of fresh products between a retailer, such as a large-scale supermarket, and a local producer.

### REFERENCE SIGNS LIST

10: advance order direct trade server
11, 11a, 11b: sales side terminal
12, 12a, 12b: purchase side terminal
13: communication network
20, 30: external storage device
21, 31: input/output interface
22a, 32a: keyboard
22b, 32b: mouse
23, 33: display
24, 34: communication interface
25, 35: processor board
26, 36: CPU
27, 37: RAM
28, 38: ROM
29, 39: system bus
40: order management program
41: inventory management program
42: advance order assignment program
43: seller DB
44: product DB
45: buyer DB
46: Inventory DB
47: order DB
48: advance order replacing means
49: advance order update means
50: fishery cooperative table
51: fishing table
52: landing result table
53: sales result table
54: delivery method table
55: delivery time table
56: delivery price table
60: fish species table
61: producer table
70: buyer table
71: advance order table
72: purchase result table
80: inventory table
81: product table
82: landing table
83: advance order table
90: order table
91: normal order table
92: normal advance order table
93: alternative order table
94: provisional advance order table
95: alternative advance order table
150: fishing port area selection screen
151: area selection button
160, 200: fish species selection screen
161, 201: fish species selection panel
170: order input screen
171: trade date designation column
172: lot column
173: desired advance order amount column
174: upper limit price column
175: search button
180: fishery cooperative order screen
181: order column
182: order state display section
183: random advance order button
184: advance order end button
190: advance order confirmation screen
191: advance order confirmation column
192: modification button
193: advance order end button
210: landing information input screen
211: size column
212: lot column
213: remarks column
214: quantity column
215: unit price column
216: transition button
220: advance order assignment confirmation screen
221: advance order assignment result column
222: end button

1. An advance order processing apparatus which executes, for one or more objects whose estimated value which is an estimated amount of acquisition and a result value that is an amount of acquisition of results decided thereafter may be different, processing of receiving an advance order including at least a desired amount of the object on the basis of the estimated value before the result value comes out and confirming an advance order on the basis of the result value after the result value comes out, the advance order processing apparatus comprising:
an estimated value storage means for storing estimated value information regarding the object;
a result value storage means for storing result value information regarding the object;
an advance order information receiving means for receiving information regarding a corresponding provisional advance order and information regarding a corresponding alternative advance order for a provisional advance order, which is made on the basis of the estimated value information regarding the object stored in the estimated value storage means and which includes at least a desired amount of the object, and an alternative advance order, which is alternatively changed to a provisional advance order if the situation is not an approval situation where all of the corresponding provisional advance orders are approved and which includes at least a desired amount of the object;
an advance order information storage means for storing information regarding provisional advance orders and information regarding alternative advance orders received by the advance order information receiving means so that the information regarding a corresponding provisional advance order and the information regarding a corresponding alternative advance order match each other;
a change mode information storage means for storing information which specifies a mode of changing an alternative advance order to a provisional advance order according to an approval situation of a provisional advance order for the information regarding the corresponding provisional advance order and the information regarding the corresponding alternative advance order stored in the advance order information storage means;
a result value information acquisition means for executing processing of acquiring result value information regarding the object and storing the acquired result value information in the result value storage means;
an advance order confirming means for executing processing of reading the information regarding a provisional advance order stored in the advance order information storage means and determining an approval situation of a provisional advance order on the basis of the result value information acquired by the result value information acquisition means and confirming the approval situation of a provisional advance order for the read information regarding the provisional advance order and executing processing of changing the storage content of the advance order information storage means so that the information regarding an advance order whose approval situation has been confirmed is deleted from objects whose approval situations are to be checked; and
an advance order update means for executing processing of reading the storage content of the change mode information storage means, changing a corresponding alternative advance order to a provisional advance order according to an approval situation of a provisional advance order confirmed by the advance order confirming means depending on the read content, and changing the corresponding storage content such that the result is reflected on the storage content of the advance order information storage means.

2. The advance order processing apparatus according to claim 1, further comprising:
an information display means for advance order reception for executing processing of displaying information for receiving an advance order from a purchase side user in the apparatus or an external terminal device,
wherein the advance order information receiving means executes processing of receiving a provisional advance order and an alternative advance order, which corresponds to the provisional advance order, according to an operation of the purchase side user, which is performed on the basis of the display content of the information display means for advance order reception, and storing the received information regarding the provisional advance order and the information regarding the alternative advance order in the advance order information storage means.

3. The advance order processing apparatus according to claim 2, further comprising:
a change mode information receiving means for executing, for the provisional advance order and the alternative advance order corresponding to the provisional advance order which are received by the advance order information receiving means, receiving information, which specifies a mode of changing an alternative advance order to a provisional advance order according to an approval situation of a provisional advance order, according to an operation of the purchase side user and storing the received information in the change mode information storage means.

4. The advance order processing apparatus according to claim 1, further comprising:
an alternative advance order candidate information decision means for executing processing of deciding, for the object, information regarding a provisional advance order and a candidate of a corresponding alternative advance order or information regarding a candidate of an alternative advance order corresponding to a provisional advance order designated by the purchase side user, on the basis of the information regarding the estimated value of the object and the information regarding advance orders stored in the advance order information storage means;
a candidate information display means for executing processing of displaying information regarding candidates decided by the alternative advance order candidate information decision means in the apparatus or an external terminal device; and
a candidate approval instruction receiving means for executing processing of receiving a candidate approval instruction according to an operation of the purchase side user, which is performed on the basis of the display content of the candidate information display means and storing advance order information regarding the instructed candidate in the advance order information storage means.

5. The advance order processing apparatus according to claim 1,
wherein an advance order mode called a normal advance order, which has priority over a provisional advance order and an alternative advance order and which includes at least a desired amount of the object, is set for the object,
also for a normal advance order made for the object on the basis of the estimated value information stored in the estimated value storage means, the advance order information receiving means receives information regarding the normal advance order and stores the received information regarding the normal advance order in the advance order information storage means, and
the advance order confirming means executes processing of reading the information regarding a normal advance order and the information regarding a provisional advance order stored in the advance order information storage means and determining an approval situation of a normal advance order and an approval situation of a provisional advance order on the basis of the result value information acquired by the result value information acquisition means and confirming the approval situation of a normal advance order and the approval situation of a provisional advance order for the read information regarding the normal advance order and information regarding the provisional advance order, and executes processing of changing the storage content of the advance order information storage means so that the information regarding an advance order whose approval situation has been confirmed is deleted from objects whose approval situations are to be checked.

6. The advance order processing apparatus according to claim 5, further comprising:
an advance order replacing means for executing processing, when there is a designation of a normal advance order overlapping a provisional advance order already present, receiving the designation of the normal advance order and also deleting information regarding the provisional advance order already present and changing information regarding an alternative advance order, which can be alternatively changed to a provisional advance order, to information regarding a provisional advance order only when there is an alternative advance order corresponding to the provisional advance order already present which can be alternatively changed to a provisional advance order,
wherein the advance order information receiving means executes processing of receiving information regarding a normal advance order according to an operation of the purchase side user, which is performed on the basis of the display content of the information display means for advance order reception, and storing the received information regarding the normal advance order in the advance order information storage means, and in this case, the advance order replacing means executes processing of reading the storage content of the advance order information storage means, determining whether or not there is an alternative advance order corresponding to the provisional advance order already present which can be alternatively changed to a provisional advance order on the basis of the read content when there is a designation of a normal advance order overlapping a provisional advance order already present, and receiving the designation of the normal advance order and also deleting information regarding the provisional advance order already present from the storage content of the advance order information storage means and changing the storage content so that the information regarding the alternative advance order which can be alternatively changed to the provisional advance order is changed to the information regarding a provisional advance order only when there is an alternative advance order corresponding to the provisional advance order already present which can be alternatively changed to a provisional advance order.

7. The advance order processing apparatus according to claim 5,
wherein “all approved” or “not approved” is used as an approval situation of a normal advance order.

8. The advance order processing apparatus according to claim 5,
wherein “all approved”, “partially approved”, or “not approved” is used as an approval situation of a normal advance order.

9. The advance order processing apparatus according to claim 1,
wherein “all approved” or “not approved” is used as an approval situation of a provisional advance order.

10. The advance order processing apparatus according to claim 1,
wherein “all approved”, “partially approved”, or “not approved” is used as an approval situation of a provisional advance order.

11. The advance order processing apparatus according to claim 1,
wherein when there is a plurality of alternative advance orders corresponding to the same provisional advance order, priorities for change to a provisional advance order are set, and
an alternative advance order priority storage means for storing information regarding priorities for change of a plurality of alternative advance orders, which corresponds to the same provisional advance order, to provisional advance orders is provided.

12. A program causing a computer that forms an advance order processing apparatus which executes, for one or more objects whose estimated value which is an estimated amount of acquisition and a result value that is an amount of acquisition of results decided thereafter may be different, processing of receiving an advance order including at least a desired amount of the object on the basis of the estimated value before the result value comes out and confirming an advance order on the basis of the result value after the result value comes out to realize:
a function of storing estimated value information regarding the object in an estimated value storage means;
an advance order information receiving function of receiving information regarding a corresponding provisional advance order and information regarding a corresponding alternative advance order for a provisional advance order, which is made on the basis of the estimated value information regarding the object stored in the estimated value storage means and which includes at least a desired amount of the object, and an alternative advance order, which is alternatively changed to a provisional advance order if the situation is not an approval situation where all of the corresponding provisional advance order are approved and which includes at least a desired amount of the object;
a function of storing, in an advance order information storage means, information regarding provisional advance orders and information regarding alternative advance orders received by the advance order information receiving function so that the information regarding a corresponding provisional advance order and the information regarding a corresponding alternative advance order match each other;
a function of storing, in a change mode information storage means, information which specifies a mode of changing an alternative advance order to a provisional advance order according to an approval situation of a provisional advance order for the information regarding the corresponding provisional advance order and the information regarding the corresponding alternative advance order stored in the advance order information storage means;
a result value information acquisition function of executing processing of acquiring result value information regarding the object and storing the acquired result value information in the result value storage means;
an advance order confirming function of executing processing of reading the information regarding a provisional advance order stored in the advance order information storage means and determining an approval situation of a provisional advance order on the basis of the result value information acquired by the result value information acquisition function and confirming the approval situation of a provisional advance order for the read information regarding the provisional advance order and executing processing of changing the storage content of the advance order information storage means so that the information regarding an advance order whose approval situation has been confirmed is deleted from objects whose approval situations are to be checked; and
an advance order update function of executing processing of reading the storage content of the change mode information storage means, changing a corresponding alternative advance order to a provisional advance order according to an approval situation of a provisional advance order confirmed by the advance order confirming function depending on the read content, and changing the corresponding storage content such that the result is reflected on the storage content of the advance order information storage means.

13. An advance order processing system comprising:
An advance order processing apparatus which executes, for one or more objects whose estimated value which is an estimated amount of acquisition and a result value that is an amount of acquisition of results decided thereafter may be different, processing of receiving an advance order including at least a desired amount of the object on the basis of the estimated value before the result value comes out and confirming an advance order on the basis of the result value after the result value comes out;
a sales side terminal device which executes processing of communicating information regarding advance order processing through a network with the advance order processing apparatus operated by a sales side user of a product as the object; and
a purchase side terminal device which executes processing of communicating information regarding advance order processing through a network with the advance order processing apparatus operated by a purchase side user of a product as the object,
wherein the advance order processing apparatus includes:
an estimated value storage means for storing estimated value information regarding the object;
a result value storage means for storing result value information regarding the object;
an advance order information receiving means for receiving information regarding a corresponding provisional advance order and information regarding a corresponding alternative advance order for a provisional advance order, which is made on the basis of the estimated value information regarding the object stored in the estimated value storage means and which includes at least a desired amount of the object, and an alternative advance order, which is alternatively changed to a provisional advance order if the situation is not an approval situation where all of the corresponding provisional advance order are approved and which includes at least a desired amount of the object;
an advance order information storage means for storing information regarding provisional advance orders and information regarding alternative advance orders received by the advance order information receiving means so that the information regarding a corresponding provisional advance order and the information regarding a corresponding alternative advance order match each other;
a change mode information storage means for storing information which specifies a mode of changing an alternative advance order to a provisional advance order according to an approval situation of a provisional advance order for the information regarding the corresponding provisional advance order and the information regarding the corresponding alternative advance order stored in the advance order information storage means;
a result value information acquisition means for executing processing of acquiring result value information regarding the object and storing the acquired result value information in the result value storage means;
an advance order confirming means for executing processing of reading the information regarding a provisional advance order stored in the advance order information storage means and determining an approval situation of a provisional advance order on the basis of the result value information acquired by the result value information acquisition means and confirming the approval situation of a provisional advance order for the read information regarding the provisional advance order and executing processing of changing the storage content of the advance order information storage means so that the information regarding an advance order whose approval situation has been confirmed is deleted from objects whose approval situations are to be checked; and
an advance order update means for executing processing of reading the storage content of the change mode information storage means, changing a corresponding alternative advance order to a provisional advance order according to an approval situation of a provisional advance order confirmed by the advance order confirming means depending on the read content, and changing the corresponding storage content such that the result is reflected on the storage content of the advance order information storage means.
